(19) United States
(12) Patent Application Publication
(10) Pub. No.: US 2017/0334144 A1
(43) Pub. Date: Nov. 23, 2017

(54) REAL-TIME LASER CONTROL FOR POWDER BED FUSION

(71) Applicant: BOARD OF REGENTS, THE UNIVERSITY OF TEXAS SYSTEM, Austin, TX (US)

(72) Inventors: Scott Fish, Austin, TX (US); Tim Phillips, Morgan Hill, CA (US); Austin McElroy, Austin, TX (US)

(21) Appl. No.: 15/597,308

(22) Filed: May 17, 2017

Related U.S. Application Data
(60) Provisional application No. 62/337,506, filed on May 17, 2016.

(51) Int. Cl. B29C 64/393; B33Y 70/00; B33Y 50/02; B33Y 40/00; B33Y 30/00; B29C 64/153; B33Y 10/00

(52) U.S. Cl. CPC B29C 64/393; B29C 64/153; B33Y 70/00; B33Y 10/00; B33Y 40/00; B33Y 30/00; B33Y 50/02

(57) ABSTRACT

Disclosed herein is a system and a method for controlling laser energy deposition in order to normalize post-sintering temperatures is presented. Sensors provide feedback for in-situ control of laser power to reduce the influence the pre-sintering thermal profile has on the post-sintering temperatures. By actively controlling the laser during its scanning, the post-sintering temperatures can be more accurately controlled, resulting in mechanical and geometric improvements in part quality.

### CROSS REFERENCE TO RELATED APPLICATION

This application claims priority to and benefit of U.S. provisional patent application Ser. No. 62/337,506, filed May 17, 2016, which is fully incorporated by reference and made a part hereof.

### BACKGROUND

Selective laser sintering (“SLS”) is an additive manufacturing technology. SLS is used to manufacture a three-dimensional component (e.g., a part) in a layer-by-layer fashion from a powder such as plastic, metal, polymer, ceramic, composite materials, etc. For example, successive layers of powder are dispensed onto a target surface (e.g., a build surface) and a directed energy beam is scanned over the build surface to sinter each layer of powder to a previously sintered layer of powder. The final part is a product of stacking successive cross sections and fusing each layer to the previous layer. The powder material may be, for example, Nylon 12 (ALM PA 650), among others.

The directed energy beam is typically a laser, which can be modulated and precisely directionally controlled. The scan pattern of the directed energy beam is controlled using a representation such as a computer-aided design (“CAD”) drawing, for example, of the part to be built. In this way, the directed energy beam is scanned and modulated such that it melts portions of the powder within the boundaries of a cross-section of the part to be formed for each layer. For example, SLS is described in detail in U.S. Pat. No. 5,053,090 to Beaman et al. and U.S. Pat. No. 4,938,816 to Beaman et al., which are incorporated by reference and made a part hereof

To create a part in an SLS machine, the designer first creates a 3D CAD model and feeds that into a slicing program. This slicer turns the 3D model into a stack of 2D geometries, each one 0.003-0.005 inches thick. These 2D geometries are what the SLS machine will sinter. To begin building the part, the machine is loaded with powder and a counter-rotating roller spreads thin layers of powder over the build surface. Radiative and conductive heaters are used to heat the powder temperature to just below the melting point of the material. Once the temperature has stabilized, the laser begins fusing the powder in the geometry dictated by the first 2D cross section. A new layer of powder is spread on top of the newly-fused powder and the geometry of the next 2D cross-section is sintered. This process is repeated until the entire part has been sintered and is detailed in FIG. 1.

Selective Laser Sintering relies on lasers to deposit patterned energy on a powder surface, raising the temperature of the surface above its melting point. A typical process control goal is to use heaters to bring the powder surface within a few degrees of the melting temperature, then use as little laser power as necessary to fully melt the powder. This process is sensitive to thermal gradients and inadequate thermal control leads to poor parts, both structurally and dimensionally. If too little energy is deposited, the material may not fully melt, leading to a structurally weak part. If too much energy is deposited, a phenomenon known as part growth may occur where the powder melts beyond the desired bounds. A third condition exists where temperature gradients cause expansion and contraction between adjacent areas of powder, curling the part

The majority of commercial SLS machines rely on inductive heaters to bring the powder surface up to temperature. Due to design constraints that limit the position of the heaters, the powder temperature can vary approximately 10-15° C. across the build surface. An infrared image of the powder surface in a commercial machine is shown in FIG. 2). One company has retrofitted some older SLS machines with quartz lamps to decrease the temperature non-uniformity across the powder surface (see, for example, Bourell, D. L., Watt, T. J., Leigh, D. K., & Fulcher, B. (2014). Performance Limitations in Polymer Laser Sintering. Physics Procedia, 147-156.), but this still results in a gradient of ˜8° C. Further advancements have been made, but there is still a gradient that must be overcome (see FIG. 3).

The Co2 laser enters the machine through a specially-coated Zinc Selenide (ZnSe) lens on the top of the chamber. This lens typically has a transmission of ˜95% for Co2 wavelength, but this transmission percent can change during a build. During the SLS process, Nylon 12 will off-gas and the “fog” created can contaminate the lens. This is not easily quantifiable as it does not affect the entire window uniformly and the transmission may drop more in some regions than others. Common practice is to clean, and sometimes polish, the lens prior to each build, but only so much of the “fog” can be removed. This “fogging” effect can decrease the transmitted laser power by up to 20-25%, and lead to uneven temperature profiles across the powder surface as the laser power is attenuated.

The geometry of the part being sintered and the way the galvanometers scan the layers can cause thermal features that can also affect the localized temperatures of powder surface. Even if the powder being used is a good thermal insulator, heat can still dissipate between layers, particularly in regions where previous layers have melted powder. If a large volume of powder has been sintered in a certain region, the temperature of the new powder spread on top of that region can be affected. This is particularly prevalent when creating features such as overhangs, where a laser scan line can go from a section of powder with no sintering underneath to a section on top of an already sintered region.

The scan style of the galvanometers also contributes to the thermal profile of the powder. The most basic scanning pattern involved scanning parallel, straight lines that overlap along their axis to ensure no un-sintered regions exist between lines. This results in a sintered region that is cooler on the first few scan lines than the bulk of the region. This is because the first few scan lines having less overlap with already sintered powder. This can be seen in FIG. 4, where the first three scan lines are cooler than the remaining eight. This figure shows the thermal data for one layer containing three tensile specimens. Each vector scan line corresponds to one of the parallel laser scan lines, where 11 lines make up the entirety of each part. More advanced scan patterns exist where the laser would sinter non-contiguous regions until the entirety of the cross-section is sintered, or a cross-hatch pattern where scan lines overlap.

Environmental conditions can also effect build quality and parameters such as temperature, humidity, oxygen levels, etc. can influence the part by affecting powder flowability, ability to maintain temperature, and sinterability of the powder. In an open-loop system, changes in these parameters are unaccounted for, while a closed-loop control system is able to compensate for changes.

In theory, a complete model of the machine and powder could be used for predictive control to change build parameters, but this is not reasonable to do in practice. SLS is a highly dynamic process and is influenced by a wide range of environmental conditions and build parameters, some still unknown.

Therefore, system and methods are needed to overcome challenges in the art, some of which are described above.

### SUMMARY

Because of the challenges described above, in-situ, feedback-based laser control is a more appropriate method for achieving an even post-sintering temperature. Described herein is in-situ control method and system as well as results from initial testing.

Described herein are devices and methods for providing real-time control of powder sintering processes, which utilize measurement of the powder temperature prior to the laser exposure to prescribe on the fly the needed laser power as a function of position across the build surface of each layer, to raise the temperature of the powder to a pre-defined optimal level or to an arbitrary special temperature profile for desired part properties.

One example method for real-time control of a powder sintering process for producing a part from a powder can include pre-computing and calibrating a function for required laser power needed to raise the candidate powder material from an array of temperatures to one or more target temperatures for the fully sintered layers with desired part properties.

Another example of a method of real-time laser control for powder bed fusion comprises obtaining a pre-sintering temperature of at least one or more points of a scan line of a powder to be sintered; determining a difference between the pre-sintered temperature of at least one of the one or more points on the scan line of the powder to be sintered and a desired temperature; and adjusting a power setting of a laser such that when the laser is applied to the at least one of the one or more points a temperature at that point is approximately the desired temperature. Optionally or alternatively, obtaining the pre-sintering temperature of at least one or more points of the scan line of a powder to be sintered comprises obtaining a pre-sintering temperature distribution of at least a portion of the scan line of a powder to be sintered. Optionally or alternatively, the pre-sintering temperature distribution can be determined for the scan line before sintering along the scan line begins. Optionally or alternatively, obtaining the pre-sintering temperature of at least one or more points of the scan line of a powder to be sintered comprises obtaining the pre-sintering temperature of the at least one or more points of the scan line of a powder to be sintered using one or more sensors. In various aspects, the one or more sensors comprise infrared sensors. For example, the infrared sensors may comprise at least one mid-wavelength infrared camera.

Yet another method of selective laser sintering (“SLS”) comprises measuring a temperature of a powder surface; determining a difference between the measured temperature and a desired temperature of the powder surface; and regulating energy deposition of a laser in order to achieve a substantially uniform post-sintering temperature. Optionally or alternatively, measuring the temperature of the powder surface comprises measuring the temperature of the powder surface along a scan line for sintering. Optionally or alternatively, the temperature of the powder surface is measured using an infrared sensor. For example, the infrared sensor may comprise a mid-wavelength infrared camera. Optionally or alternatively, the difference between the measured temperature and the desired temperature of the powder surface can be determined along the scan line. Optionally or alternatively, the determined difference between the measured temperature and the desired temperature of the powder surface along the scan line can be used to create a thermal profile along the scan line. Optionally or alternatively, the thermal profile for the scan line is created before sintering along the scan line begins. Optionally or alternatively, the thermal profile is used to dynamically regulate energy deposition of the laser on the powder as the laser moves along the scan line to achieve the substantially uniform post-sintering temperature. Optionally or alternatively, the powder may comprise Nylon 12 (ALM PA 650) powder.

An example apparatus for producing a part from a powder using a powder sintering process can include a bore sighted thermal camera operating at a wavelength different from the scanning laser and yet able to resolve temperature in the range of interest for the powder both in the pre-lased and post-lased condition, and associated control system to leverage pre-lased measurements and drive laser power on the fly.

Another example apparatus for producing a part from a powder using a powder sintering process comprises a build chamber including one or more walls, wherein the build chamber encloses a build cylinder and a build surface; a build piston configured to support the powder and the part, wherein the build piston is arranged at least partially within the build cylinder; an energy source configured to produce and direct an energy beam to the build surface; one or more temperature measurement devices; and a controller, wherein the controller executes computer-readable instructions that cause the controller to obtain a temperature of the powder surface, determine a difference between the measured temperature and a desired temperature of the powder surface; and regulate energy deposition of the energy source in order to achieve a substantially uniform post-sintering temperature. Optionally or alternatively, the apparatus further comprises a plurality of heat sources distributed in at least one of the walls of the build chamber, the build cylinder and the build piston, wherein the controller further executes computer-readable instructions to control the heat sources. Optionally or alternatively, the energy source is arranged outside of the build chamber. Optionally or alternatively, the controller controls the heat sources to maintain an approximately uniform temperature distribution within the build chamber during the powder sintering process. Optionally or alternatively, the one or more temperature measurement devices comprise at least one multi-spectral imaging device that acquires images of measuring the temperature of the powder surface along a scan line for sintering. Optionally or alternatively, the multi-spectral imaging device is an infrared imaging device. For example, the infrared sensor may comprise a mid-wavelength infrared camera. Optionally or alternatively, the controller executes computer-readable instructions that cause the controller to determine the difference between the measured temperature and the desired temperature of the powder surface along the scan line. Optionally or alternatively, the controller executes computer-readable instructions that cause the controller to use the determined difference between the measured temperature and the desired temperature of the powder surface along the scan line to create a thermal profile along the scan line. Optionally or alternatively, the thermal profile for the scan line is created before sintering along the scan line begins. Optionally or alternatively, the controller executes computer-readable instructions that cause the controller to use the thermal profile to dynamically regulate energy deposition of the laser on the powder as the laser moves along the scan line to achieve the substantially uniform post-sintering temperature. Alternatively or optionally, the at least one multi-spectral imaging device comprise a bore-sighted multi-spectral imaging device. Alternatively or optionally, the apparatus further comprises an energy beam power meter configured to measure a power of the energy beam, wherein the energy beam power meter is arranged near the build surface within the build chamber, and wherein the controller executes computer-readable instructions that cause the controller to regulate energy deposition of the energy source in order to achieve a substantially uniform post-sintering temperature by receiving the power of the energy beam; and control the energy source based on the power of the energy beam measured within the build chamber.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The accompanying drawings, which are incorporated in and constitute a part of this specification, illustrate embodiments and together with the description, serve to explain the principles of the methods and systems. The patent or application file contains at least one drawing executed in color. Copies of this patent or patent application publication with color drawing(s) will be provided by the Office upon request and payment of the necessary fee:

FIG. 1 is an exemplary illustration of a selective sintering process;

FIG. 2 is an infrared image of the powder surface in a commercial machine;

FIG. 3 is an image of a LAMPS temperature gradient;

FIG. 4 is a graph illustrating scan line temperatures in successive scans;

FIG. 5 is a diagram illustrating an apparatus for producing a part from a powder using a powder sintering process;

FIG. 6 is a diagram illustrating heat sources of the apparatus shown in FIG. 1;

FIG. 7 is a diagram illustrating inlet or outlet ports of the apparatus shown in FIG. 1;

FIG. 8 is a diagram illustrating a powder feed device of the apparatus shown in FIG. 1;

FIG. 9 is a diagram illustrating a powder spreading device of the apparatus shown in FIG. 1;

FIG. 10 is a diagram illustrating a bore-sighted multi-spectral imaging device of the apparatus shown in FIG. 5;

FIG. 11 is a block diagram of an example computing device;

FIG. 12 is an image of a LAMPS (Laser Additive Manufacturing Pilot System) that was designed and built at the University of Texas, Austin as an experimental testbed;

FIG. 13 is an image of a view via a FLIR A325 long-wavelength infrared (LWIR) camera that views the build surface and serves as the feedback for the quartz lamps PID (Proportional Integral Derivative) control loop;

FIG. 14 is an image of a view from a camera that captures images in the human visible spectrum that is part of the LAMPS described herein;

FIG. 15 and FIG. 16 are images that show the setup for co-aligning the laser and field of view of the MWIR camera prior to the path entering the scanning system, the resulting image from the MWIR camera is a close up view of the powder surface with the laser spot fixed near the center of the image, regardless of spot position in the build chamber where the co-aligning is accomplished using a dichroic mirror that allows the Cot laser to pass through unobstructed and reflects the MWIR radiation into the camera;

FIG. 17 is an example image of the data recorded by the MWIR camera;

FIG. 18 is an example of the temperature distribution due to end of vector over-sintering where in this figure, two scan lines are shown and both have a large temperature spike at the start of sintering and another, smaller spike at the end of sintering;

FIG. 19 shows a more acceptable tuning for velocity compensation where measurements for both FIG. 18 and FIG. 19 were taken on the LAMPS machine described herein;

FIG. 20 shows the pre-sintering and post-sintering temperatures when using 10% laser power where the second subplot is the same data with the pre-sintering temperature shifted upward to coincide with the post-sintering temperature;

FIG. 21 shows the same data as that for FIG. 20 for 45% laser power and yields the same result;

FIG. 22 shows similar data as that for FIGS. 20 and 21, but for a line that was split into two parts with a different power for each part. The figure shows that at both power levels, the temperature mimics the pre-sintering temperature gradient and that the only undesirable effect is a small region between the lines where the power ramps up;

FIGS. 23, 24 and 25 illustrate data collected to compare sintering lines with different laser power percentages and compare the pre-sintering and post-sintering temperature where powers of 5% to 50% were tested in 5% increments, with four test runs at each power percentage. The test consisted of using the galvanometers to scan the bore-sighted MWIR camera over the scan line to record the initial temperature profile. Then the galvanometers scanned the same region using that test's fixed laser power. The data was analyzed and the average temperature increase for each scan line was determined. One of these trials, where laser powers of 5%, 10%, 15%, 20%, and 25% were tested is given in FIG. 23. The average temperature increase for each test is shown in FIG. 24, with the difference between the pre-sintering temperature and the post-sintering temperature shown on the y axis and the laser power shown on the x axis. FIG. 25 shows this data with a 4th order polynomial fit to the data;

FIG. 26 is an example of how a fixed laser power affects the post-sintering temperature;

FIG. 27 illustrates an example result of in-situ laser control;

FIG. 28 illustrates an example of dynamic subsection spacing where a new subsection is created once the predicted temperature of the previous subsection reaches a certain limit;

FIGS. 29A-29N are illustrations of result plots for a total of 13 in-situ laser control trials that were run, the majority of which showed vast improvements over the baseline, constant power trials;

FIG. 30 is an IR image taken with the boresight MWIR camera where the figure identifies the pixel on the IR camera that the laser is currently firing at (the hottest pixel in view);

FIG. 31 is an illustration of the temperature of the laser spot pixel for all 1500 frames during one of the baseline trials;

FIG. 32 is an illustration that shows how the post-sintering temperature tracks that of the pre-sintering temperature;

FIG. 33 is illustrates powder cooling temperatures where the data in this figure was taken immediately following the laser turning off when the galvanometer is stationary. The blue line is the temperature recorded at the pixel corresponding to the center of the laser spot and the green line is the nearest pixel that was outside the laser spot, a mere three pixels (approximately 2.5 mm) away from the center of the laser. As can be seen, over the 0.25 seconds recorded, the laser spot pixel cooled rapidly while the adjacent point's temperature was unchanged;

FIG. 34 illustrates a pre-sintering temperature profile for one of the trials where the first subplot shows the raw temperature data from the pre-scan with the first 340 and the last 1100 frames being dwell time for the galvanometer and the second subplot shows a close-up of the non-dwell time region which is the temperature profile of the scan line;

FIG. 35 illustrates a laser power profile after the pre-sintering temperature of FIG. 34 is fed through the laser power to temperature increase transfer function with a desired post-sintering temperature of 9000 Counts;

FIG. 36 illustrates raw results of the described in-situ laser control trial; and

FIG. 37 displays the same data as FIG. 36 with the dwell times removed and the pre-sintering temperature and post-sintering temperature coinciding where the red line is the same as the line in FIG. 34, the pre-sintering temperature that is used to determine the subsection laser power percentages, and the blue line is data from the same location as the red line, but roughly two minutes later.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where the feature, event or circumstance occurs and instances where it does not. While implementations will be described for providing real-time control of SLS processes, it will become evident to those skilled in the art that the implementations are not limited thereto, but are applicable for providing real-time control of other powder sintering processes.

An example is provided herein of an SLS device that can be used to implement aspects of the disclosure. Similar devices are also described in US Pre-Grant Publication 2015/0165681 to Fish et al., which is fully incorporated by reference and made a part hereof. It is to be appreciated that aspects of the invention are not to be limited to the machine described herein and made be applied and used on other powder-sintering devices.

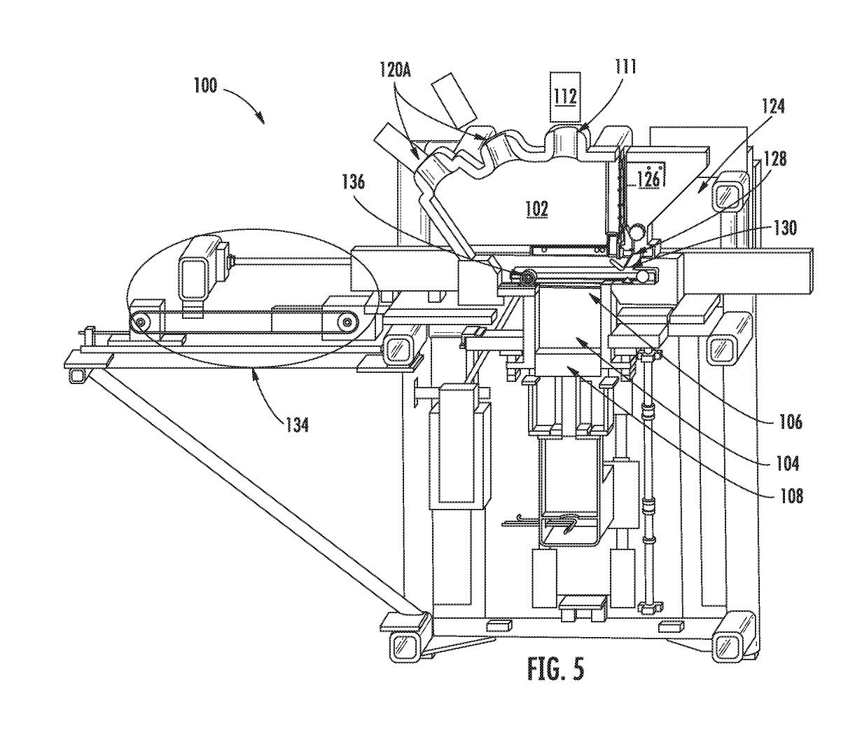

Referring now to FIG. 5, a diagram illustrating an apparatus 100 for producing a part from a powder using a powder sintering process is shown. An example powder sintering process is SLS, which is used to manufacture a three-dimensional component in a layer-by-layer fashion from a powder, as described above. As used herein, the powder sintering process can include both the part build-up process and the part cool-down process. This disclosure contemplates that the powder can be a material including, but not limited to, plastics, metals, polymers, ceramics and composite materials. The apparatus 100 can include a build chamber 102. The build chamber 102 is the portion of the apparatus 100 in which the part is formed through the powder sintering process. In addition, the build chamber 102 can include one or more walls and can enclose a build cylinder 104 and a build surface 106. The build cylinder 104 is the portion of the build chamber 102 that contains the powder and part (e.g., the part cake) during the powder sintering process. As used herein, the part and powder can be referred to as the part cake, e.g., the mass of powder in which the part is formed. The build surface 106 is at the top of the build cylinder 104, for example, a region where the powder is spread before sintering. The apparatus 100 can also include a build piston 108, which is configured to support the powder and part (e.g., the part cake) during the powder sintering process. In other words, the part cake is supported on the build piston 108. As shown in FIG. 5, the build piston 108 is arranged at least partially within the build cylinder 104. As described above, the part is formed in a layer-by-layer fashion, for example, by depositing and sintering successive layers of powder. The build piston 108 can therefore be configured to incrementally move downward within the build cylinder 104 after sintering each layer of powder, thus, permitting the next layer of powder to be deposited and spread over the build surface 106 before sintering.

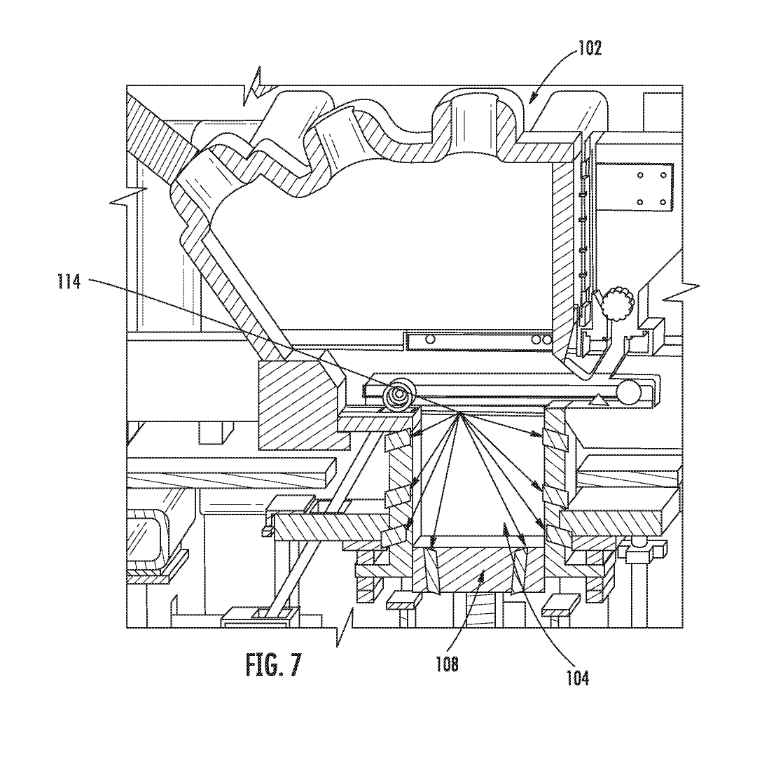

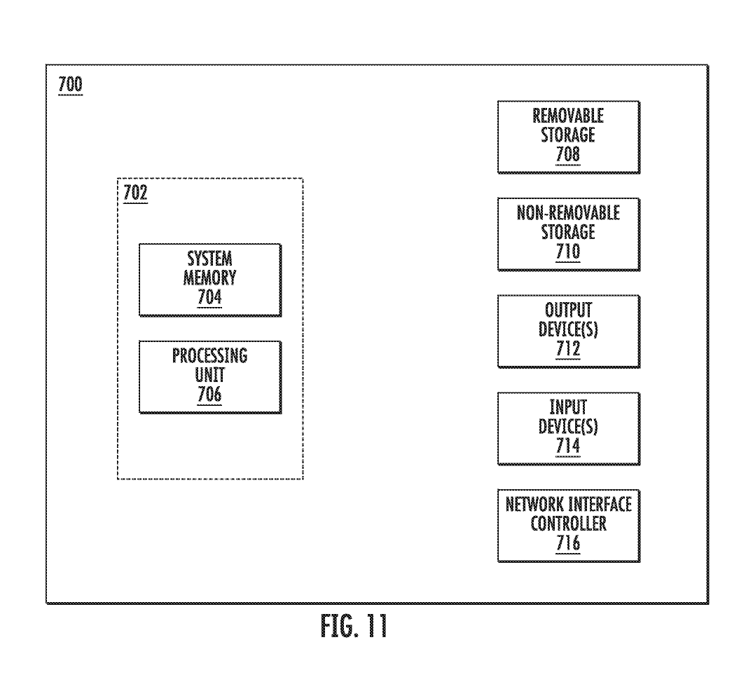

A plurality of heat sources can be distributed throughout the build chamber 102. For example, heat sources can be distributed in the walls of the build chamber, the build cylinder and/or the build piston. For example, as shown in FIG. 7, heat sources 110 are provided in the walls of the build chamber 102, the build cylinder 104 and the build piston 108. Additionally, a size and/or a shape of the build chamber 102 and/or the arrangement of the heat sources 110 can minimize flow over the build surface 106. It should be understood that the size and shape of the build chamber 102, as well as the number and arrangement of the heat sources 110, shown in FIG. 7 are provided only as an example. Therefore, this disclosure contemplates that one skilled in the art could design a build chamber having different sizes and shapes and/or numbers and arrangements of heat sources according to this disclosure. The heat sources 110 can be selectively, and optionally individually, controlled to maintain an approximately uniform temperature distribution within the build chamber 102 during the powder sintering process. For example, a controller (e.g., the controller described with regard to FIG. 11) can be used to send a signal to energize/de-energize each of the heat sources. By maintaining uniform temperature distribution within the build chamber 102, it is possible to minimize or eliminate temperature variations over the build surface 106, which minimizes or eliminates natural thermal convention patterns (which are sometimes turbulent) induced by temperature variations. The natural thermal convention patterns induced by temperature variations in conventional build chambers result in non-uniform heat transfer, which can result in pre-mature part failure, for example, caused by internal stresses during the manufacturing process.

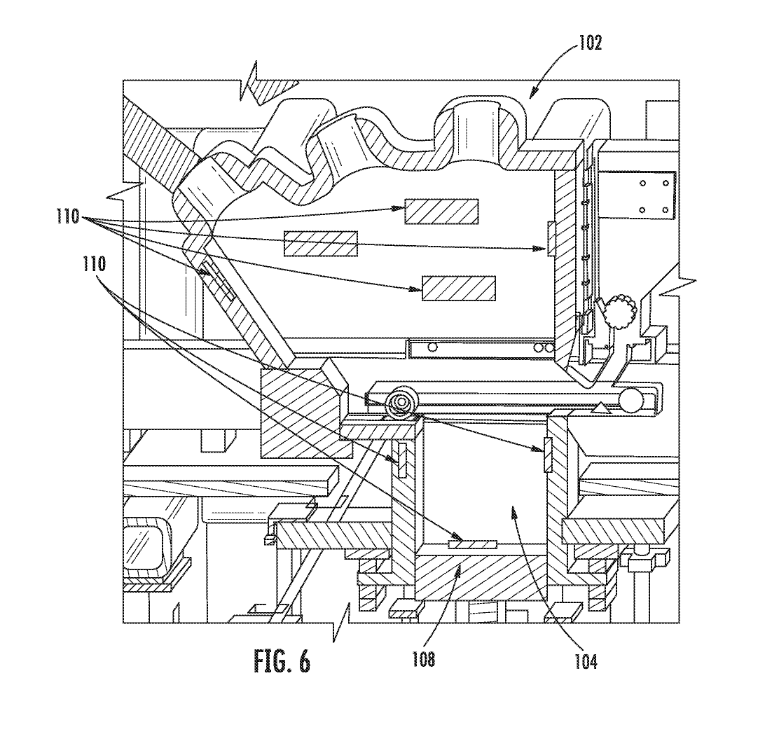

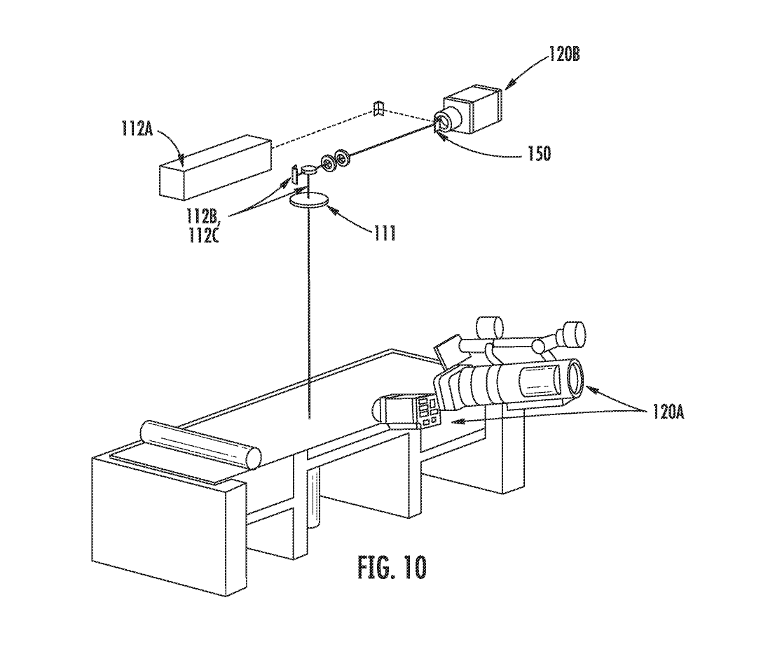

The apparatus 100 can also include an energy source 112. As shown in FIG. 5, the energy source 112 can be arranged outside of the build chamber 112. An example energy source is also shown in FIG. 10. The energy source 112 can be configured to produce and direct an energy beam through a window (e.g., window 111 shown in FIG. 10) in the build chamber 102 to the build surface 106. For example, the energy source 112 can include a laser (e.g., laser 112A shown in FIG. 10). The type of laser can be selected, for example, based on the type of powder to be sintered. Lasers are well-known in the art and are therefore not described in further detail. Although a laser is used as an example, this disclosure contemplates using other types of energy beams to sinter the powder. Additionally, a system of lenses, prisms, mirrors, etc. can be used to focus and control the scanning pattern of energy beam (e.g., the laser). As described above, the energy beam can be scanned over the build surface 106 in order to melt portions of powder within the boundaries of a cross-section of the part to be formed. A controller (e.g., the controller described with regard to FIG. 11) can be configured to use a CAD drawing, for example, to determine the boundaries of the cross-section of the part to be formed for each successive layer of powder deposited and spread over the build surface 106. The controller can also be configured to modulate (e.g., turn ON/OFF) the laser when the energy beam is directed within/outside the cross-section of the part to be formed. Further, the controller can be configured to drive steering mirrors (e.g., mirrors 112B, 112C shown in FIG. 10), for example, to scan the energy beam over the build surface 106. For example, the controller can be configured to send a signal that drives a first galvanometer to precisely position a first mirror (e.g., mirror 112B shown in FIG. 10) to scan the energy beam in the x-direction, and the controller can be configured to send a signal that drives a second galvanometer to precisely position a second mirror (e.g., mirror 112C shown in FIG. 10) to scan the energy beam in the y-direction. The first and second mirrors can be mounted at right angles to one another, and the energy beam can be directed from the first and second mirrors through the window (e.g., window 111 shown in FIG. 10) into the build chamber 102. It should be understood that energy beam control and scanning systems are also well known in the art and that the components illustrated in FIG. 6 are provided only as an example. Thus, this disclosure contemplates that one skilled in the art could design an energy source having more or less components than shown in FIG. 10.

The build cylinder 104 and/or the build piston 108 can include one or more inlet or outlet ports formed therein for accommodating a flow of build chamber gases. Optionally, an inlet port can be a gas inlet port for supplying gas to the build chamber 102. Optionally, an outlet port can be a gas outlet port for exhausting gas from the build chamber 102. FIG. 7 illustrates a plurality of inlet or outlet ports 114 formed in the build cylinder 104 and the build piston 108 of the build chamber 102. It should be understood that the inlet and outlet ports 114 shown in FIG. 7 are provided only as an example and that other numbers and/or arrangements of the ports can be used. In addition, a controller (e.g., the controller described with regard to FIG. 11) can be configured to control operation of the inlet or outlet ports, for example by sending a signal to open/close the inlet or outlet ports, to adjust a temperature and/or a chemical composition of the build chamber gases. In other words, the controller can selectively, and optionally individually, open/close each of the inlet or outlet ports. This disclosure contemplates using variable (or multiple) atmospheric conditions during the powder sintering process, which includes both the product build up and subsequent cool down. The atmospheric conditions can be optimized for heat transfer and/or chemical action control during different phases of the powder sintering process. Thus, by opening/closing the inlet or outlet ports, it is possible to supply certain gases (e.g., O₂, N₂, air, or other gas at desired temperatures) and/or exhaust of gases to/from the build chamber 102 to achieve the desired atmospheric conditions during the powder sintering process. Alternatively or additionally, the inlet or outlet ports can be controlled to supply/exhaust gases to maintain the part being built at variable temperatures during the powder sintering process. For example, the variable temperatures can be optimized for powder sintering and annealing of induced internal stresses in the part. For example, a hot gas can optionally be supplied through one or more of the inlet ports in the build cylinder 104 or the build piston 108 in order to heat/maintain the part cake (e.g., the part and powder) at an elevated temperature as compared to the temperature of the build chamber to achieve a stress relief anneal.

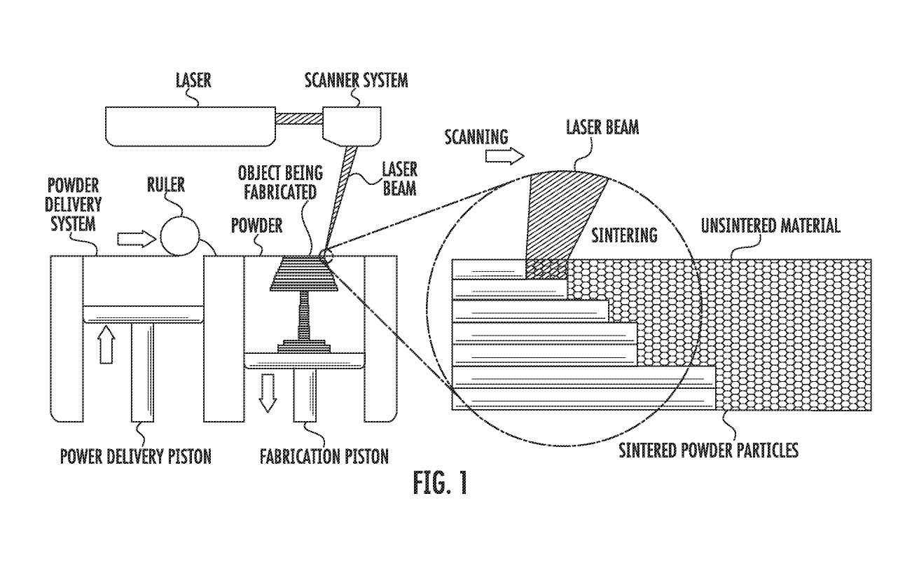

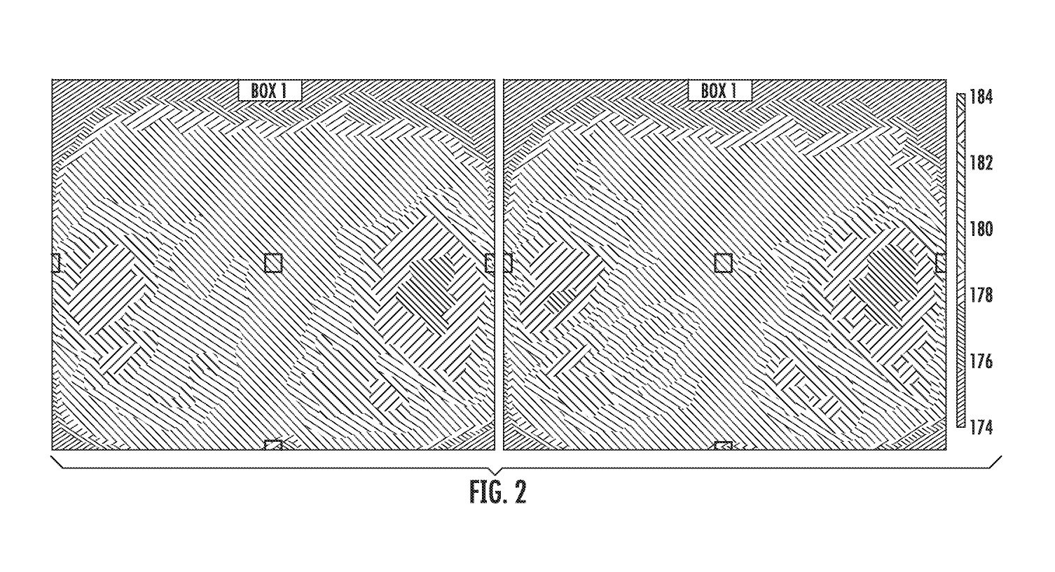

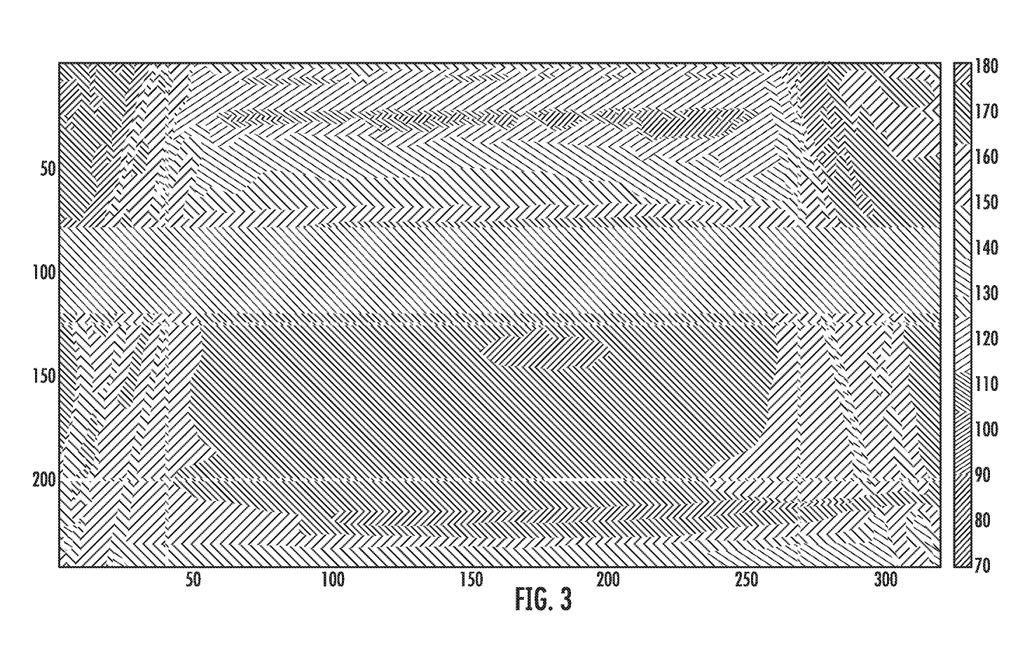

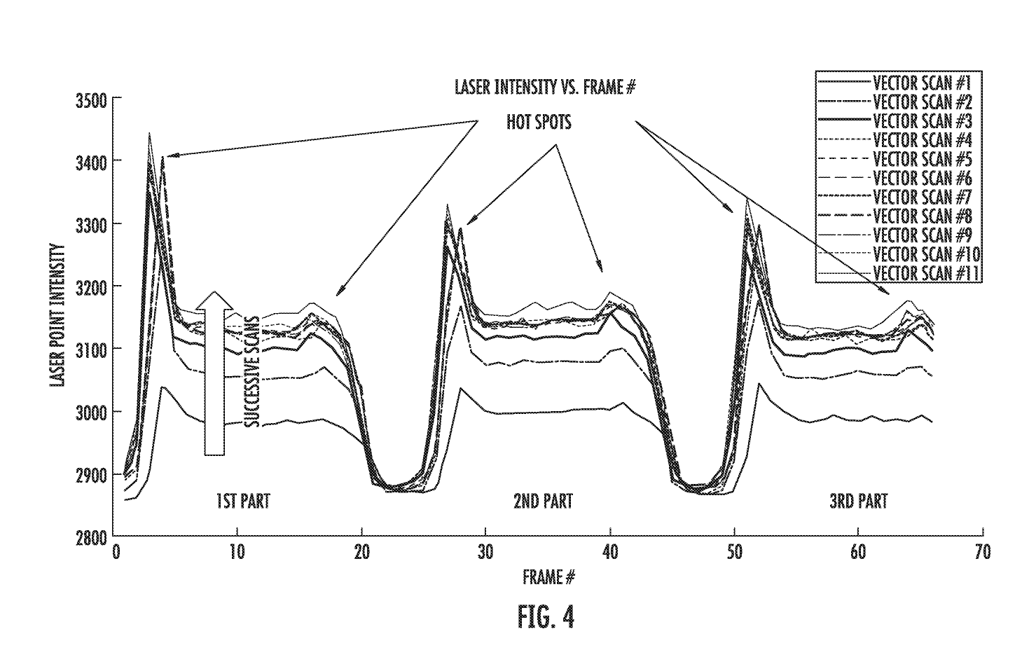

The apparatus 100 can also include a powder feed device 124 arranged outside of the build chamber 102. The powder feed device 124 is also shown in FIG. 10. The powder feed device 124 can include a powder feed bin 126, a powder metering device 128 and a powder drop chute 130. As shown in FIGS. 1 and 4, the powder metering device 128 can be arranged between the powder feed bin 126 and the powder drop chute 130. The powder feed bin 126 is configured to store the powder, for example, at a temperature at which the powder is not degraded. The powder metering device 128 is configured to dispense a measured amount of the powder from the powder feed bin 126. For example, the powder metering device 128 can optionally be a rotating cylinder with longitudinal slots. The slots can hold a desired amount of the powder (e.g., the measured amount of the powder). When the cylinder rotates, the measured amount of the powder is dropped into the powder drop chute 130, which is configured to guide the measured amount of the powder into the build chamber 102. The powder drop chute 130 can be configured to deliver the measured amount of the powder to a position 131 near the build surface 106 within the build chamber 102. As described below, the measured amount of the powder can be dropped in a position where a powder spreading device can spread the powder over the build surface 106. As shown in FIG. 10, the position 131 can be slightly spaced apart from the build surface 106. Optionally, a strip heater 132 can be arranged in the build chamber 102 at the position 131 near the build surface 106. Alternatively or additionally, a lamp heater 133 can be arranged in the build chamber 102 in proximity to the position 131 near the build surface 106. The strip heater 132 and/or the lamp heater 133 can be energized/de-energized, for example with a controller (e.g., the controller described with regard to FIG. 11), to heat the measured amount of powder to the desired temperature before spreading it over the build surface 106.

The powder metering device 128 and the powder drop chute 130 can be configured to scatter the measured amount of the powder such that the measured amount of the powder undergoes rapid heat transfer as the powder enters the build chamber 102. As described above, the powder is stored in the powder feed bin 126, for example, at a temperature below which the powder does not degrade. Upon entering the build chamber 102, the measured amount of powder can undergo rapid heat transfer (e.g., flash) to a higher temperature. For example, the powder can rapidly increase in temperature from the approximate temperature of the powder feed bin to a temperature that minimizes thermal mismatch between the powder and the build surface 106 when the powder is spread. This minimizes the amount of heat transfer between each successive layer of powder spread over the existing part cake, which minimizes thermal stresses and associated part curl. In contrast, when there is thermal mismatch between the powder and the existing part cake, temperature gradients can induce thermal stresses that might damage the part being built. Optionally, as described above, the strip heater 132 and/or the lamp heater 133 can also be used to heat the powder to the desired temperature before spreading the powder over the build surface 106.

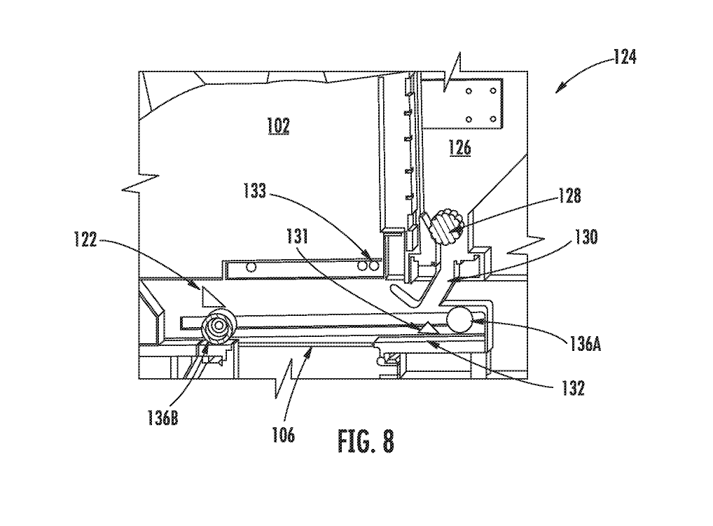

The apparatus 100 can also include an energy beam power meter (e.g., the laser power meter 122 shown in FIG. 8) configured to measure a power of the energy beam. The energy beam power meter can be arranged near the build surface 106 within the build chamber 102. Thus, it is possible to conduct in-situ beam calibration (e.g., adjust characteristics of the energy beam such as energy beam power) during the build process based on the actual energy beam characteristics (e.g., power) inside the build chamber 102 at or near the point where the energy beam impacts the build surface 106. For example, a controller (e.g., the controller described with regard to FIG. 11) can be configured to receive the power of the energy beam detected by the energy beam power meter, and control the energy source based on the power of the energy beam measured within the build chamber 102. In a build chamber, the window through which the energy beam passes can become contaminated due to outgassing of the powder during heating/sintering. These contaminants can absorb or divert power from the intended powder heating point with resulting variation in part properties through the depth of the part cake. Alternatively or additionally, the energy beam source can degrade over time. By measuring energy beam power in the build chamber 102, it is therefore possible to compensate for beam degradation over time either associated with conditions external to the build chamber 102 (e.g., energy beam source degradation) or internal to the build chamber 102 (e.g., contamination of window through which the energy beam passes).

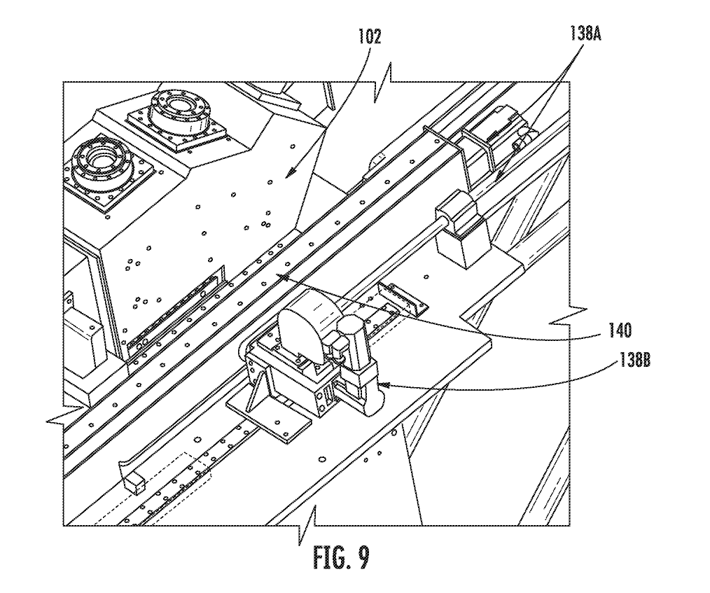

The apparatus 100 can also include a powder spreading device 134. The powder spreading device 134 can be configured to enable fine control the thickness of each successive layer of powder during the powder sintering process. The powder spreading device 134 is also shown in FIG. 9. The powder spreading device 134 can include a powder spreading roller 136, a drive system 138A and 138B (collectively referred to as 138) and a thermal box 140. The powder spreading roller 136 can be arranged within the build chamber 102, and the drive system 138 and thermal box 140 can be arranged outside of the build chamber 102. The thermal box 140 can provide thermal isolation between the build chamber 102 and the drive system 138. For example, the thermal box 140 can include one or more thermal seals between the build chamber 102 and components (e.g., bearings, seals, actuators, etc.) of the drive system 138, which prevents the components of the drive system 138 being exposed to high ambient temperatures of the build chamber 102 (e.g., greater than 350 degrees Celsius). In addition, the drive system 138 can be configured to independently control translation and rotation of the powder spreading roller. Optionally, the drive system can include a translation drive system 138A configured to independently control the translation of the powder spreading roller 136, e.g., as shown in FIG. 8, translation between the position of the powder spreading roller 136A before spreading the measured amount of the powder (e.g., the powder dropped at the position 131 near the build surface 106) over the build surface 106 and the position of the powder spreading roller 136B after spreading the measured amount of the powder over the build surface 106. The drive system can also include a rotation drive system 138B configured to independently control the rotation of the powder spreading roller 136, e.g., a rotation counter (or opposite) to the direction of translation. By providing independent, multi-axis (e.g., rotation and translation) of the powder spreading roller 136, it is possible to enable flat and non-flat powder layer deposition, as well as variable compaction properties, over the build surface 106.

The apparatus 100 can optionally include a multi-spectral imaging device 120A configured to acquire images of the build surface 106, the powder, the part, the walls of the build chamber 102 and/or the build cylinder 104. Optionally, the multi-spectral imaging device 120A can be used to acquire images of at least two of the build surface 106, the powder, the part, the walls of the build chamber 102 and/or the build cylinder 104 (e.g., as opposed to acquiring only images of a single region such as the build surface 106, for example). As shown in FIG. 5, the multi-spectral imaging device 120A can be arranged outside the build chamber 102 and acquire images through windows in the build chamber 102. The multi-spectral imaging device 120A can optionally be an infrared (“IR”) imaging device. Although an IR imaging device is used in the example provided below, it should be understood that imaging devices that operate in other portions of the electromagnetic spectrum can be used. Then, using a controller (e.g., the controller described with regard to FIG. 11), respective temperature distributions of the build surface 106, the powder, the part, the walls of the build chamber 102 and/or the build cylinder 104 can be estimated from the images acquired by the multi-spectral imaging device 120A. This information can be used as feedback to provide real-time control the energy source (e.g., the energy source 112 shown in FIGS. 1 and 6), the heat sources (e.g., heat sources 110 shown in FIG. 6) and/or the inlet or outlet ports (e.g., inlet and outlet ports 114 shown in FIG. 7). For example, using the controller, it is possible to adjust characteristics (e.g., power, scan pattern, scan rate, etc.) of the energy beam. Alternatively or additionally, it is possible to energize/de-energize one or more of the heat sources. Alternatively or additionally, it is possible to open/close one or more of the inlet or outlet ports. As described above, by controlling the energy source, heat sources and/or inlet or outlet ports, it is possible to provide real-time control of the build chamber environment (e.g., temperature, temperature distribution, chemical composition, etc.) and/or the part cake conditions (e.g., temperature, temperature distribution, etc.) during the powder sintering process. This can provide the capability to adaptively control the thermal temperature time history with an increased level of detail, which can facilitate higher predictability and performance in the adaptive manufacturing process.

Optionally, physics and cyber-enabled manufacturing (“CeMs”) process controls can be implemented to control the powder sintering processes described herein. CeMs process controls use high-fidelity physics-based models, as well as real-time measurements, to control the powder sintering process. For example, the physics-based models can provide a theoretical or computational model(s) of the energy beam-powder interaction region, flow and distribution of thermal energy in the build chamber and/or flow and distribution of thermal energy in the part cake. As used herein, the energy beam-powder interaction region includes a point where the energy beam intersects the build surface (e.g., the build surface 106 shown in FIG. 5) and can optionally include a melt pool (e.g., at least a portion of the melted powder) on the build surface. The physics-based models depend on the characteristics of the build chamber, operating conditions and the type of powder material used in the powder sintering process. Optionally, a controller (e.g., the controller described with regard to FIG. 11) can be used to compute the physics-based models. Optionally, in some scenarios, multiple controllers (e.g., multiple controllers described with regard to FIG. 11) can be used to compute the physics-based models in parallel (e.g., parallel processing). In some implementations, the theoretical or computational model can be used as feedback to provide real-time control the energy source (e.g., the energy source 112 shown in FIGS. 1 and 6), the heat sources (e.g., heat sources 110 shown in FIG. 6) and/or the inlet or outlet ports (e.g., inlet and outlet ports 114 shown in FIG. 7). In other implementations, the respective temperature distributions estimated from the images acquired by the multi-spectral imaging device 120A can be compared with the theoretical or computational model. In other words, the real-time operational characteristics measured during the powder sintering process can be compared with the predicted operational characteristics of the theoretical or computational model. Then, this information can be used as feedback to provide real-time control the energy source (e.g., the energy source 112 shown in FIGS. 1 and 6), the heat sources (e.g., heat sources 110 shown in FIG. 6) and/or the inlet or outlet ports (e.g., inlet and outlet ports 114 shown in FIG. 7). Similar as described above, this can provide the capability to adaptively control the thermal temperature time history with an increased level of detail, which can facilitate higher predictability and performance in the adaptive manufacturing process.

Alternatively or additionally, the apparatus 100 can optionally include a bore-sighted multi-spectral imaging device (e.g., the bore-sighted multi-spectral imaging device 120B shown in FIG. 10). The bore-sighted multi-spectral imaging device 120B can optionally be an IR imaging device. Although an IR imaging device is used in the example provided below, it should be understood that imaging devices that operate in other portions of the electromagnetic spectrum can be used. The bore-sighted multi-spectral imaging device 120B can be configured to acquire images of the energy beam-powder interaction region on the build surface, e.g., a point where the energy beam intersects the build surface (e.g., the build surface 106 shown in FIG. 5) and can optionally include a melt pool (e.g., at least a portion of the melted powder) on the build surface. In other words, the bore-sighted multi-spectral imaging device 120B can be configured to acquire images of the energy beam-powder interaction region as the energy beam scans across the build surface 106. For example, this can be achieved by aligning an acquisition axis of the bore-sighted multi-spectral imaging device 120B with an axis of the energy beam, which is shown in FIG. 10 where the bore-sighted multi-spectral imaging device 120B acquires images through a pass-through mirror 150. It should be understood that the images of the energy beam-powder acquisition region are reflected, for example, by the first and second mirrors 112B, 112C (which also incrementally steer the energy beam) and pass through the pass-through mirror 150 (which reflects the energy beam having a certain wavelength/frequency) for acquisition by the bore-sighted multi-spectral imaging device 120B as the energy beam scans across the build surface 106.

Similar as described above, using a controller (e.g., the controller described below with regard to FIG. 11), it is possible to estimate real-time properties of the energy beam-powder interaction region from the images acquired by the bore-sighted multi-spectral imaging device 120B. In addition, physics-based models can be computed to provide a theoretical or computational model(s) of the energy beam-powder interaction region for an energy beam-powder interaction region for a similar powder material under similar build chamber conditions as described above. Then, using the controller, the estimated real-time properties of the energy beam-powder interaction region acquired by the bore-sighted multi-spectral imaging device 120B can be compared with the theoretical or computational model. Then, this information can be used as feedback to provide real-time control the energy source (e.g., the energy source 112 shown in FIGS. 1 and 6), the heat sources (e.g., heat sources 110 shown in FIG. 6) and/or the inlet or outlet ports (e.g., inlet and outlet ports 114 shown in FIG. 7). The theoretical or computational models (and the comparison) can be used to identify potential flaws in the buildup process and/or make adjustments to the energy source and/or the overall thermal control system (e.g., the build chamber environment including heat sources and/or inlet or outlet ports) to maximize part property predictability and performance. This information can also enable a three-dimensional record of process/part quality for certification purposes. In one aspect, the bore-sighted multi-spectral imaging device 120B comprises a bore-sighted thermal camera operating at a wavelength different from the scanning laser and yet able to resolve temperature in the range of interest for the powder both in the pre-lased and post-lased condition, and associated control system to leverage pre-lased measurements and drive laser power on the fly.

Alternatively or additionally, the apparatus 100 can optionally include a non-optical imaging device configured to acquire images of the powder and the part. For example, the non-optical imaging device can be an acoustic or electro-magnetic imaging device. The non-optical imaging device can be arranged outside of the build chamber and can acquire images through the walls of the build chamber, for example. The non-optical imaging device can be used to acquire three-dimensional images of the part, the powder and/or the part cake, which can be used to identify/characterize the three-dimensional properties of the part within the part cake during the powder sintering process. These images can be used to identify/characterize conditions (e.g., defects, non-uniformities, etc.) of the part during the powder sintering process. Similar to above, this information can be used as feedback to provide real-time control the energy source (e.g., the energy source 112 shown in FIGS. 1 and 6), the heat sources (e.g., heat sources 110 shown in FIG. 6) and/or the inlet or outlet ports (e.g., inlet and outlet ports 114 shown in FIG. 7). Accordingly, this information can enable the ability to make adjustments to the energy source and/or the overall thermal control system (e.g., the build chamber environment including heat sources and/or inlet or outlet ports) to potentially mitigate properties created in earlier parts of the build process.

As described above, the real-time process controls described herein can minimize premature additive manufacturing part failure due to hidden flaws associated with poor process management, as well as can enable additive manufacturing processing at higher environmental conditions while maintaining real-time control to reduce the induction of internal stresses in the manufactured parts. For example, conventional additive manufacturing technologies do not provide adaptive control of the thermal temperature time history at the level of detail enabled by the process controls described herein, which enable higher predictability and performance in resulting manufactured parts.

It should be appreciated that the logical operations described herein with respect to the various figures may be implemented (1) as a sequence of computer implemented acts or program modules (i.e., software) running on a computing device, (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

When the logical operations described herein are implemented in software, the process may execute on any type of computing architecture or platform. For example, referring to FIG. 11, an example computing device (e.g., a controller) upon which embodiments of the invention may be implemented is illustrated. The computing device 700 may include a bus or other communication mechanism for communicating information among various components of the computing device 700. In its most basic configuration, computing device 700 typically includes at least one processing unit 706 and system memory 704. Depending on the exact configuration and type of computing device, system memory 704 may be volatile (such as random access memory (RAM)), non-volatile (such as read-only memory (ROM), flash memory, etc.), or some combination of the two. This most basic configuration is illustrated in FIG. 11 by dashed line 702. The processing unit 706 may be a standard programmable processor that performs arithmetic and logic operations necessary for operation of the computing device 700. As used herein, “processor” refers to a physical hardware device that executes encoded instructions for performing functions on inputs and creating outputs.

Computing device 700 may have additional features/functionality. For example, computing device 700 may include additional storage such as removable storage 708 and non-removable storage 710 including, but not limited to, magnetic or optical disks or tapes. Computing device 700 may also contain network connection(s) 716 that allow the device to communicate with other devices. Computing device 700 may also have input device(s) 714 such as a keyboard, mouse, touch screen, etc. Output device(s) 712 such as a display, speakers, printer, etc. may also be included. The additional devices may be connected to the bus in order to facilitate communication of data among the components of the computing device 700. All these devices are well known in the art and need not be discussed at length here.

The processing unit 706 may be configured to execute program code encoded in tangible, computer-readable media. Computer-readable media refers to any media that is capable of providing data that causes the computing device 700 (i.e., a machine) to operate in a particular fashion. Various computer-readable media may be utilized to provide instructions to the processing unit 706 for execution. Common forms of computer-readable media include, for example, magnetic media, optical media, physical media, memory chips or cartridges, a carrier wave, or any other medium from which a computer can read. Example computer-readable media may include, but is not limited to, volatile media, non-volatile media and transmission media. Volatile and non-volatile media may be implemented in any method or technology for storage of information such as computer readable instructions, data structures, program modules or other data and common forms are discussed in detail below. Transmission media may include coaxial cables, copper wires and/or fiber optic cables, as well as acoustic or light waves, such as those generated during radio-wave and infra-red data communication. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 706 may execute program code stored in the system memory 704. For example, the bus may carry data to the system memory 704, from which the processing unit 706 receives and executes instructions. The data received by the system memory 704 may optionally be stored on the removable storage 708 or the non-removable storage 710 before or after execution by the processing unit 706.

Computing device 700 typically includes a variety of computer-readable media. Computer-readable media can be any available media that can be accessed by device 700 and includes both volatile and non-volatile media, removable and non-removable media. Computer storage media include volatile and non-volatile, and removable and non-removable media implemented in any method or technology for storage of information such as computer readable instructions, data structures, program modules or other data. System memory 704, removable storage 708, and non-removable storage 710 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer storage media may be part of computing device 700.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, temperatures, pressures and other reaction ranges and conditions that can be used to optimize the product purity and yield obtained from the described process.

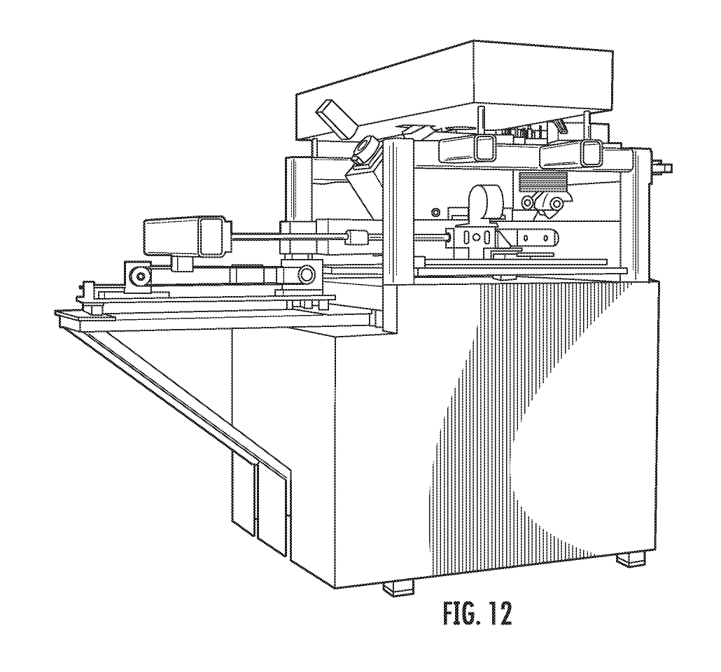

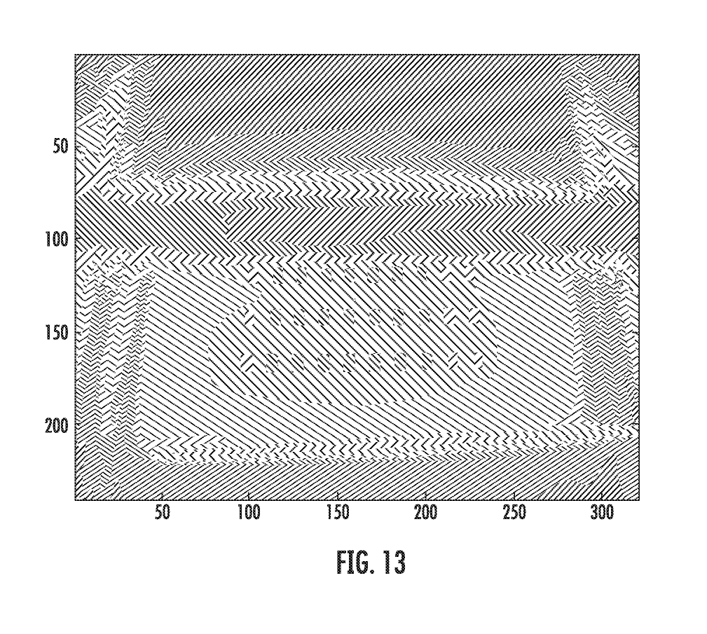

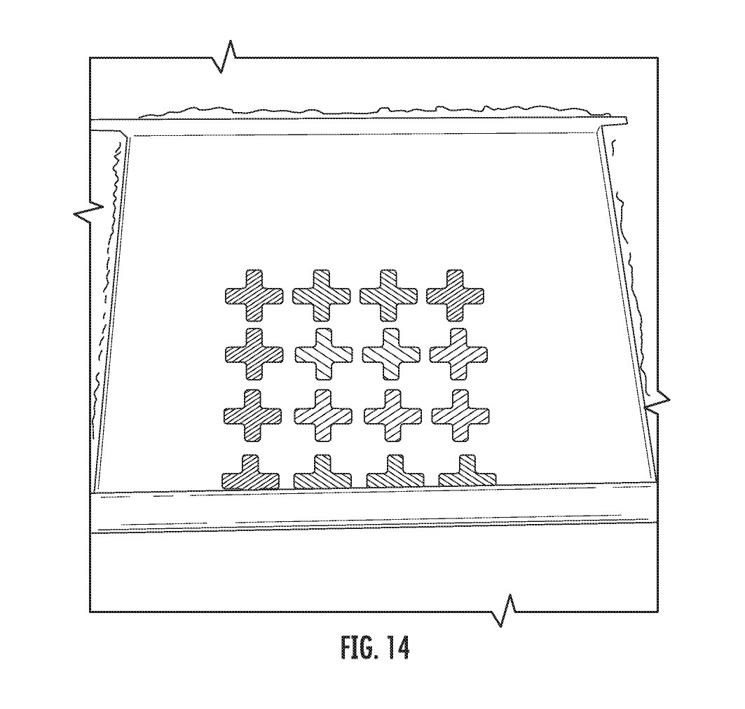

Described herein is a LAMPS (Laser Additive Manufacturing Pilot System) that was designed and built at the University of Texas, Austin as an experimental testbed and is seen in FIG. 12. This LAMPS machine has a build surface of 220 mm×220 mm and sinters using a 60 watt Cot laser with a Cambridge Technologies EC1000 laser and galvanometer controller. The atmosphere is nitrogen and the temperature is controlled via strip heaters placed throughout the walls of the machine. These heaters each have a thermocouple attached to them and are regulated through a PID controller housed on a National Instruments cRIO. These heaters do the bulk of the heating for LAMPS and bring the temperature of the powder surface to just below the desired temperature. The fine tuning of temperatures is done with 3 quartz lamps. These are controlled via a FLIR A325 long-wavelength infrared (LWIR) camera that views the build surface and serves as the feedback for the quartz lamps PID loop. The view of this camera is seen in FIG. 13. In addition to the strip heater thermocouples and the A325, the machine contains ambient thermocouples, a visible camera that captures images in the human visible spectrum (view seen in FIG. 14), and a FLIR SC8240 mid-wavelength infrared (MWIR) camera, which is detailed herein.

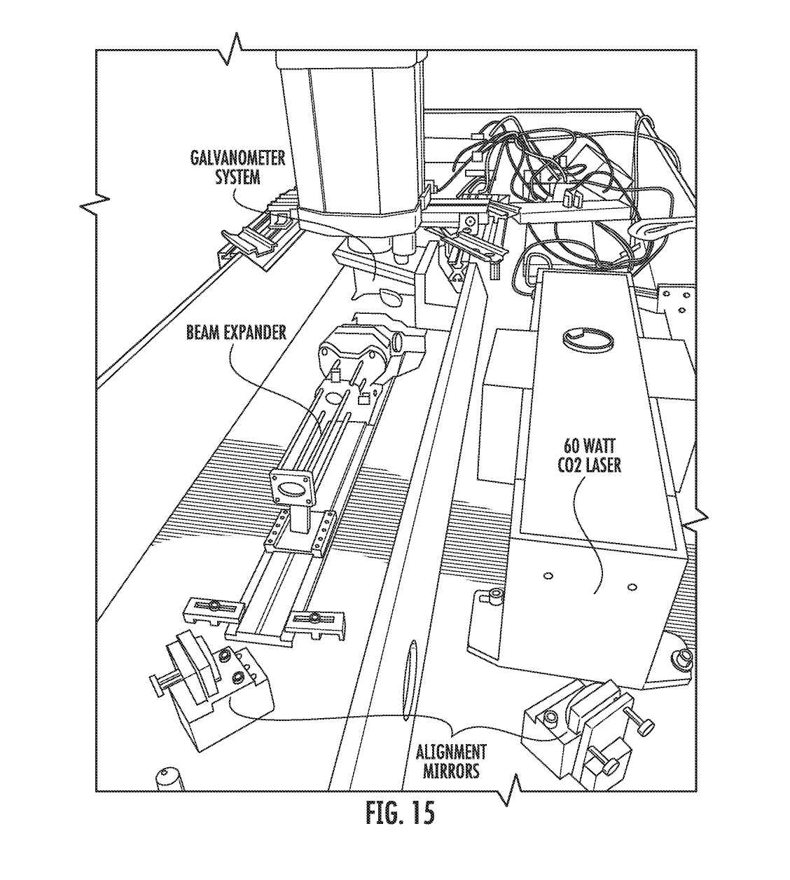

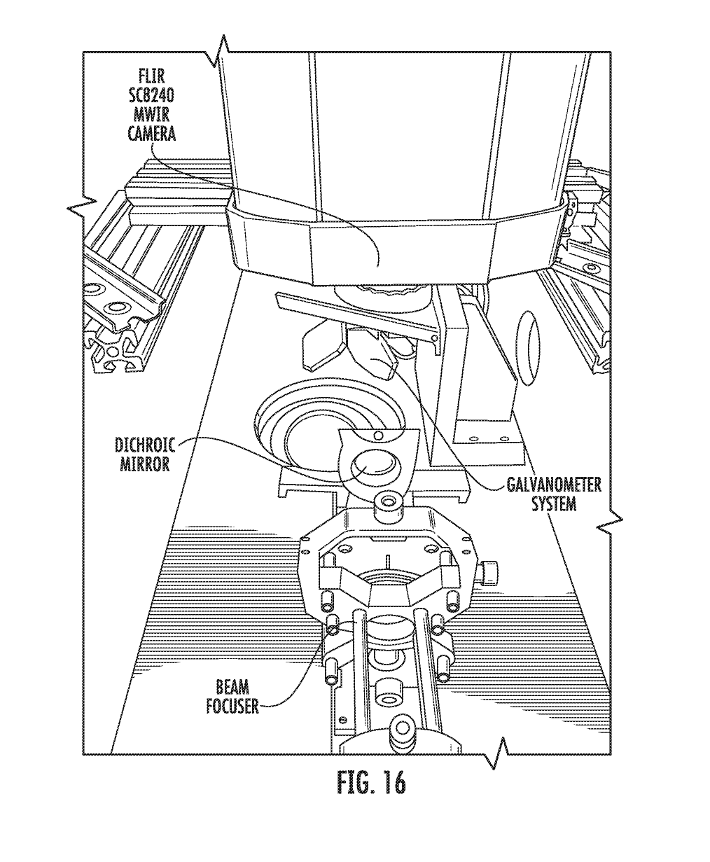

The FLIR SC8240 camera is a high-speed, mid-wave infrared camera capable of recording at 2,243 frames per second at 64×64 pixels. The camera is mounted in the laser box of the LAMPS machine and is bore-sighted with the laser beam, prior to going into the galvanometer system. By co-aligning the laser and field of view of the MWIR camera prior to the path entering the scanning system, the resulting image from the MWIR camera is a close up view of the powder surface with the laser spot fixed near the center of the image, regardless of spot position in the build chamber. The co-aligning is accomplished using a dichroic mirror that allows the Co2 laser to pass through unobstructed and reflects the MWIR radiation into the camera. The setup is shown in the photographs of FIG. 15 and FIG. 16.

The motivation for using a MWIR camera, as opposed to a LWIR is due to the wavelength of the Co2 laser. The Co2 laser, at 10.6 μm, sits in the LWIR spectrum, defined as 8-14 μm. Sensors in this range will measure the radiation emitted by the powder as well as reflection of the laser, making powder temperature measurements difficult. Along with recording inaccurate temperature measurements, this can damage the camera by sending too much radiation to the camera sensor, causing pixels to burn out. The MWIR spectrum is 3-5 μm, meaning the MWIR camera will pick up the radiation in this band emitted from the powder as it is heated, while not measuring the longer wavelength laser reflection. This allows for accurate readings of the powder currently being sintered with the laser.

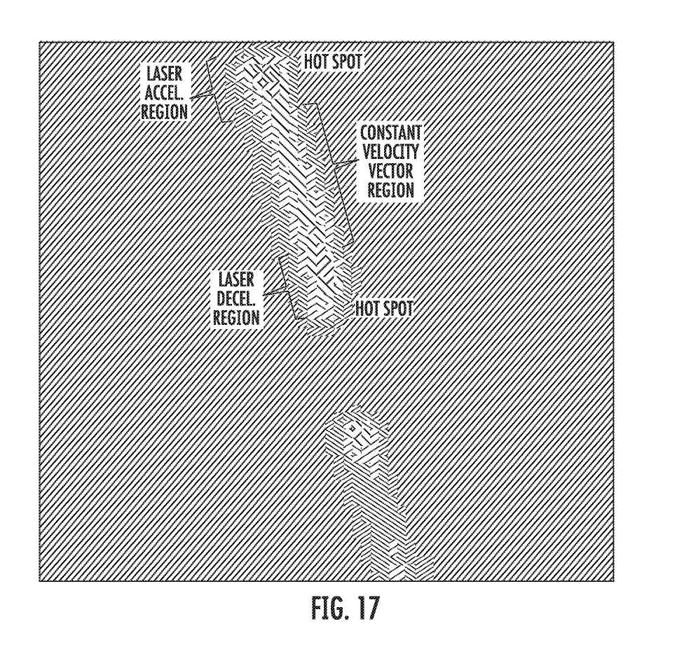

The MWIR bore-sighted camera enables sensing not seen before in polymer SLS machines. The camera's IR spectrum and framerate allow for precise measurements of laser-polymer interaction. An example of the data recorded by the MWIR camera is shown in FIG. 17. This figure shows a sub-optimal velocity compensation tuning, something unable to be precisely measured previously. Velocity compensation is a tuning parameter available on the EC1000 control board that controls laser power to compensate for changes in galvanometer velocity. The galvanometers have a finite mass and are incapable of changing velocity instantaneously, meaning the beginning and end of vectors have an acceleration period. If the laser power is set to a constant value during the acceleration period, more energy is deposited in these end of vectors and the powder is heated more than the rest of the line. This phenomenon is known as end of vector over-sintering and can cause a build to be unsuccessful. In other words, the bore-sighted thermal camera operates at a wavelength different from the scanning laser and yet is able to resolve temperature in the range of interest for the powder both in the pre-lased and post-lased condition, and associated control system to leverage pre-lased measurements and drive laser power on the fly.

Many of the figures in this section use the temperature unit of “counts.” This unit is proportional to the energy recorded by the IR camera and is the unit exported by the FLIR SC8240 MWIR camera. It is possible to convert this unit to Celsius, but is dependent on the properties of the optical track and object being measured. These properties, such as transmittance of the optics, emissivity of the powder, and reflected radiation, are not precisely known for each test and can even change slightly throughout a test. Therefore, it was decided to leave the unit as counts, but to give a sense of scale, 7900 counts is roughly equal to 177° C. and a 400 count change is equal to a change of roughly 3.8° C.

In-situ laser control requires two distinct actions: acquiring and analyzing data, and controlling laser energy deposition based on that analysis. It is theoretically possible to accomplish both these tasks simultaneously; however, the laser described in these examples moves at 1,500 mm/sec with a spot size of 800 μm. This means a voxel of powder will only see the laser for tenths of a millisecond, making it challenging to perform the analysis and implement laser control before the laser has passed on with the current hardware.

The FLIR SC8240 MWIR camera offers framerates up to 2,243 Hz, one of the highest framerates in class. Accepting the Nyquist theorem, this suggests framerates in excess of 4,000 Hz are needed to precisely control the temperature of each voxel of powder using this simultaneous data collection and implementation strategy. These limitations suggest that a multiple scan control strategy would be more practical and would provide enough time to react to the data.

Laser and galvanometer control is accomplished using a Cambridge Technologies EC1000 controller. This controller is highly capable but does have limitations. The controller does not allow a user to vary the laser power or galvanometer speed mid-scan. This means that variable energy deposition will need to be accomplished by breaking the scan line into multiple segments and specifying different, fixed speeds or powers for each segment as an independent scan line.

The proposed multiple scan strategy separates the control into two steps. During the first step, the galvanometers scan the bore-sighted MWIR camera and laser across the build surface as if they were sintering that layer, but with zero or nearly zero laser power. The MWIR camera is used to record the initial powder temperature, giving the initial temperature gradient of the powder surface where the laser is going to sinter. The temperature is analyzed and a scan strategy is developed to produce a line with a constant temperature, regardless of the initial temperature profile.

The second step is to employ the scan strategy developed in the first step to scan the laser over the desired line with the variable power it requires. The MWIR camera continues to record in this phase and is used to verify the scan strategy by examining the post-sintering temperature of the powder.

A second, similar strategy for multiple scans is to have the laser on at a low, fixed power during the first step and then continue to the second step as described previously. An advantage of this method is that it deposits less energy during each scan, potentially reducing effects of thermal gradients, and it can allow the galvanometers to move at a higher speed. A disadvantage of this strategy is that if the first, low-powered laser pass encounters a hot spot it is possible to increase its temperature above the final desired temperature and the hot spot will be propagated throughout multiple layers.

A third scan strategy is to scan the entire layer with the laser at a fixed power as is done during a normal build. Once the scan has finished, use the MWIR camera to record the post-sintering temperature of the powder bed and identify cold regions. Next, scan the laser at a lower power over only the cold regions in an attempt to bring them up to the same temperature as the rest of the powder. The advantage of this strategy is that it could potentially be faster than the other proposed strategies as it records and analyzes temperature data only once, for the entire layer, rather than for each individual scan line. A disadvantage is that all closed-loop control is lost on the first laser pass and it is possible to create a temperature profile that is unable to be repaired on the second scan.

These examples will generally focus on the first proposed scan strategy, as it provides the highest level of control and is less sensitive to the delayed timescale that arise from the software and hardware limitations.

Galvanometers have a finite mass and, therefore, do not accelerate instantaneously. This may cause over sintering at the beginning and end of scan lines if not taken into account, as seen in FIG. 4. This end of vector over sintering is a serious issue and can cause a build to crash. In order to get a constant energy deposition throughout a scan line, the laser needs to either ramp up in power during the acceleration phase of the galvanometer, or delay firing until the galvanometer speed has stabilized. Due to the EC1000 limitation that necessitates the scan line be split into many subsections, it is imperative that this be tuned prior to using the in-situ laser control strategy discussed above. If the velocity compensation is not tuned correctly, each beginning and end of vector will display a temperature spike, so the in-situ control strategy of splitting a scan line into many subsections will yield a line with many, large temperature spikes throughout the scan line where the subsections meet.

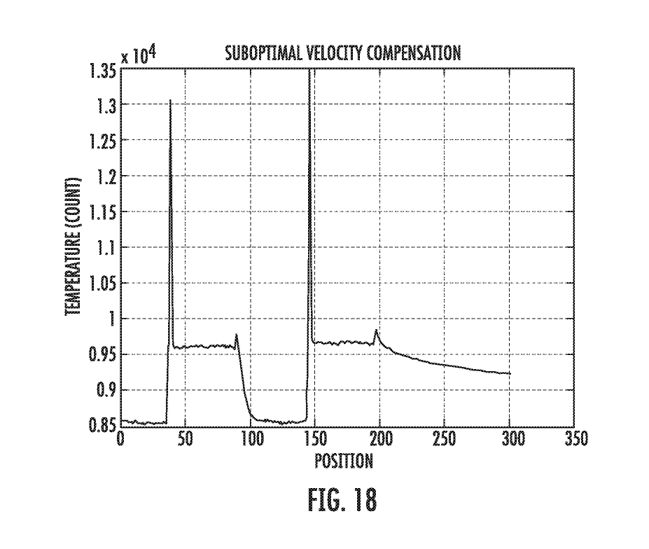

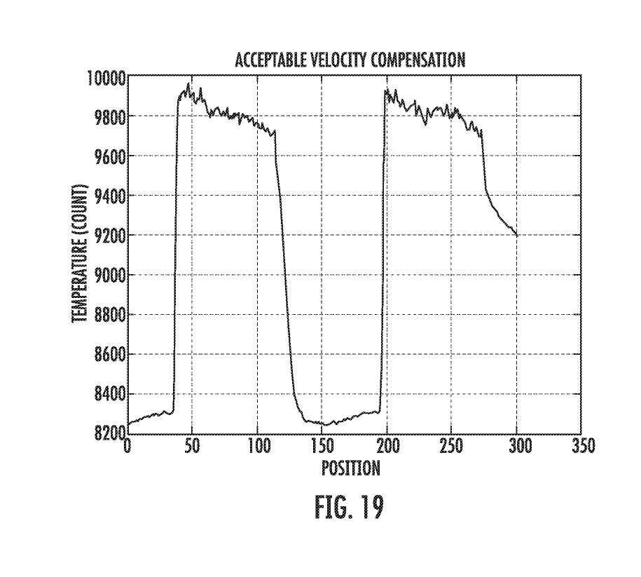

In commercial SLS production environments, a sheet of Mylar is placed on the build surface and the markings of the laser are examined and used to adjust the velocity compensation parameters. This method is effective for tuning the parameters enough so that they do not crash a build, but lacks the definition required for in-situ control purposes. The bore-sighted MWIR camera has proven to be a useful tool for properly adjusting the velocity compensation with a high level of precision. End of vector over sintering can be clearly seen through the MWIR and parameters are adjusted until the temperature distribution in a scan line is sufficient. An example of the temperature distribution due to end of vector over sintering can be seen in FIG. 18. In this figure, two scan lines are shown and both have a large temperature spike at the start of sintering and another, smaller spike at the end of sintering. FIG. 19 shows a more acceptable tuning for velocity compensation. Measurements for both FIG. 18 and FIG. 19 were taken on the LAMPS machine described herein.

On the other end of the spectrum, if the velocity compensation is too aggressive, the laser will take a long time to reach the desired power. This can cause cold regions at the beginning and end of vectors, where the laser power is still ramping up while the galvanometers are moving full speed. A tradeoff exists where the laser power ramps up quickly, but does not overshoot the desired level of energy deposition.

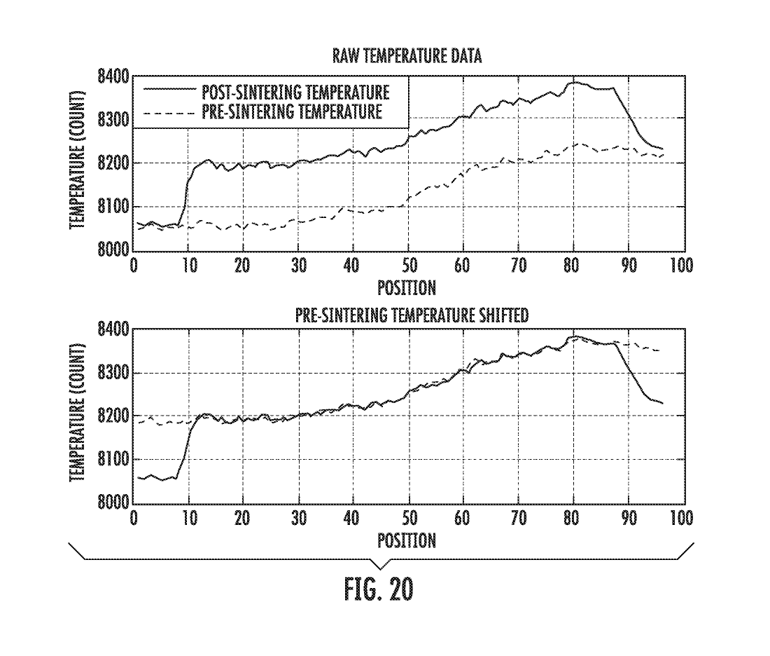

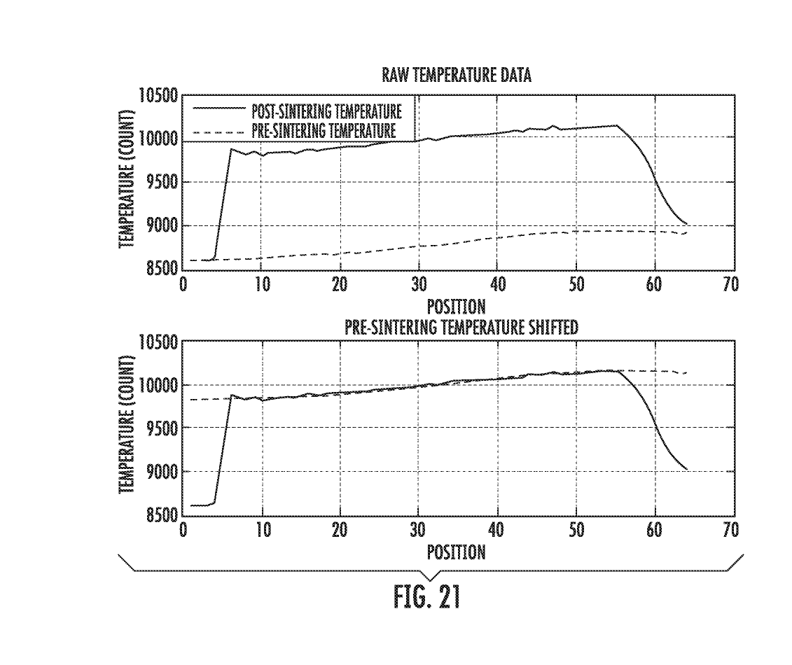

In order to use in-situ control of the laser power, the relationship between laser power and resulting temperature increase must be known. It is possible to build a thermal model that can predict temperature increase based on energy deposited, but that would require validation and would likely be influenced by machine parameters that are not precisely known. Therefore, experimental data was used to create a laser power to powder temperature transfer function. The first step was to verify the hypothesis that a constant laser power would uniformly increase the powder temperature, preserving its original temperature gradient. FIG. 20 shows the pre-sintering and post-sintering temperatures when using 10% laser power. The second subplot is the same data with the pre-sintering temperature shifted upward to coincide with the post-sintering temperature. It is clear that the post-sintering temperature mimics the pre-sintering temperature. FIG. 21 shows the same data for 45% laser power and yields the same result. After more, similar tests, it is concluded that constant laser power preserves pre-sintering temperature gradients. Note that there is no large temperature spikes at end of vectors thanks to proper velocity compensation tuning.

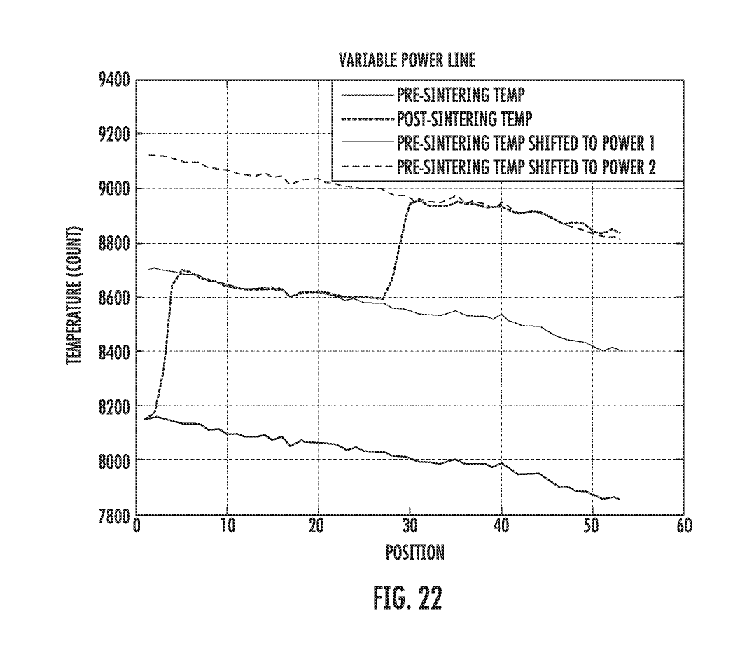

FIG. 22 shows similar data, but for a line that was split into two parts with a different power for each part. The figure shows that at both power levels, the temperature mimics the pre-sintering temperature gradient and that the only undesirable effect is a small region between the lines where the power ramps up. This region is deemed acceptable since it is so small, but further velocity compensation tuning may be able to diminish this further.

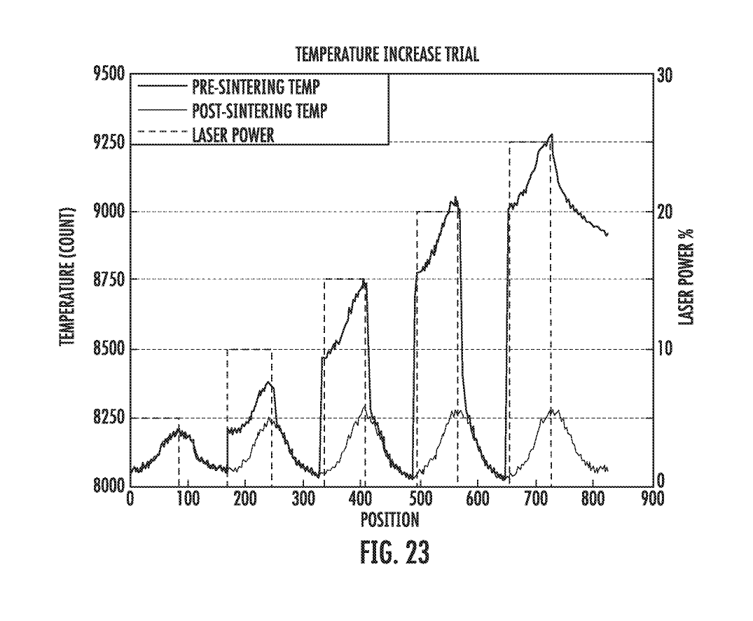

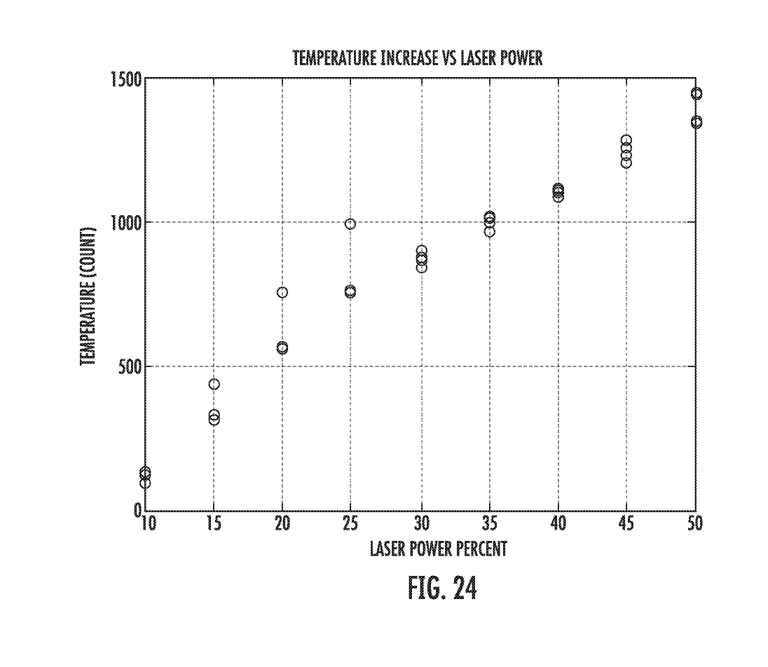

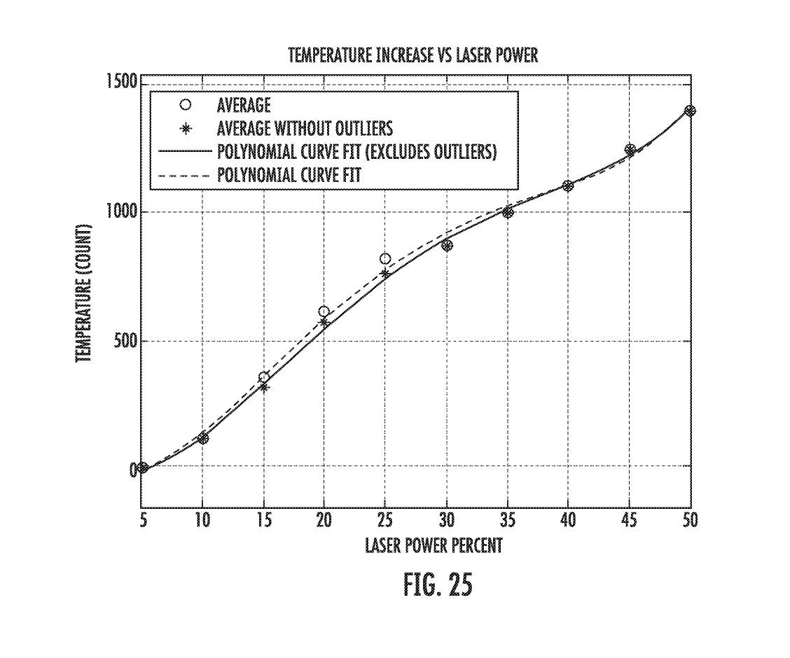

The next step was to sinter lines with different laser power percentages and compare the pre-sintering and post-sintering temperature. Powers of 5% to 50% were tested in 5% increments, with four test runs at each power percentage. The test consisted of using the galvanometers to scan the bore-sighted MWIR camera over the scan line to record the initial temperature profile. Then the galvanometers scanned the same region using that test's fixed laser power. The data was analyzed and the average temperature increase for each scan line was determined. One of these trials, where laser powers of 5%, 10%, 15%, 20%, and 25% were tested is given in FIG. 23. The average temperature increase for each test is shown in FIG. 24, with the difference between the pre-sintering temperature and the post-sintering temperature shown on the y axis and the laser power shown on the x axis. FIG. 25 shows this data with a 4th order polynomial fit to the data. At 15%, 20%, and 25% laser power there was one outlier value each. These values were recorded on the first test of those percentages and it was decided that these were questionable data points and they were to be excluded when making the laser power to temperature increase transfer function. The curve fit to the remaining data had an R2 value of 0.9988 and was used as the laser power to temperature increase transfer function.

The strategy for sintering a single line is split into three phases. The first phase is to move the galvanometers to the beginning of the scan line. This phase is not critical and no data is recorded. The purpose of this phase is simply to make the calculations in the following phase easier by ensuring only temperature data of the scan line is recorded. The second phase is to scan the camera over the scan line with zero or near zero laser power. This gives the original temperature distribution of the scan line, which is fed into the MATLAB program that computes the difference between the pre-sintering temperature and the desired temperature. The program then uses the laser power to temperature increase transfer function to parse the line into subsections that each have a constant, integer value of power and uses that data to create a scan file that is sent to the Cambridge EC1000. The final phase returns the galvanometers to the beginning of the scan line and uses the scan file created in the previous phase to sinter the line using the variable power percentages defined by each subsection.

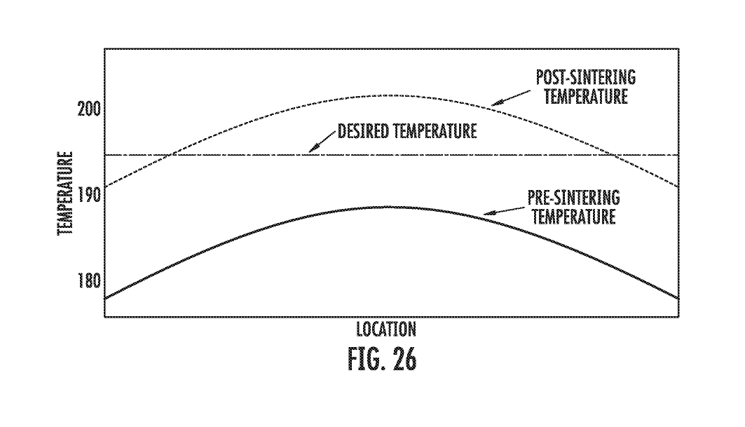

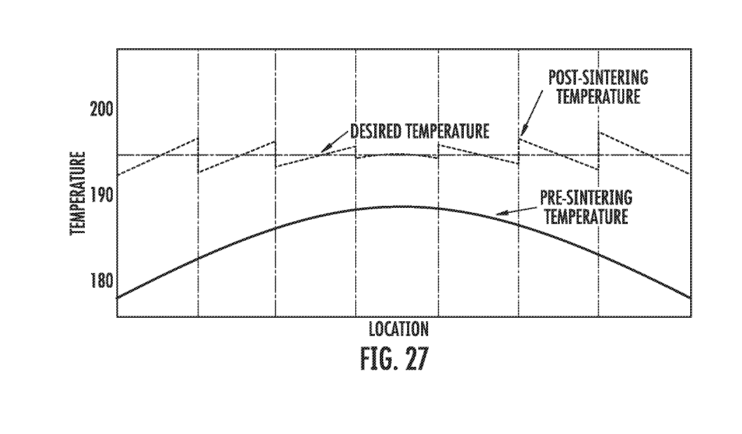

An example of how a fixed laser power affects the post-sintering temperature is seen in FIG. 26. As can be seen, the post-sintering temperature mimics the pre-sintering temperature and deviates from the desired temperature. An example result of in-situ laser control is seen in FIG. 27. Using a large subsection size, the closed loop laser control scheme will create a sawtooth-like resultant temperature with much less deviation from the desired temperature than an open loop control scheme. As the subsection size decreases, this deviation will also decrease.

In theory, the subsection spacing can be reduced to the length of a single pixel on the MWIR camera, effectively turning the laser into a pulsed source that delivers the exact amount of energy to raise each voxel of powder to the desired temperature. This will drive the error between the actual and desired post-sintering temperature to zero, but is likely not be the most effective means of in-situ control. There are a number of disadvantages to this method, including increasing the computation time and difficulty. For the high resolution MWIR camera, this method can result in hundreds of thousands of temperatures per layer that need to be analyzed. Another disadvantage is that any amount of error in the laser power control or velocity compensation will be compounded and lead to a poor thermal profile of the build surface.

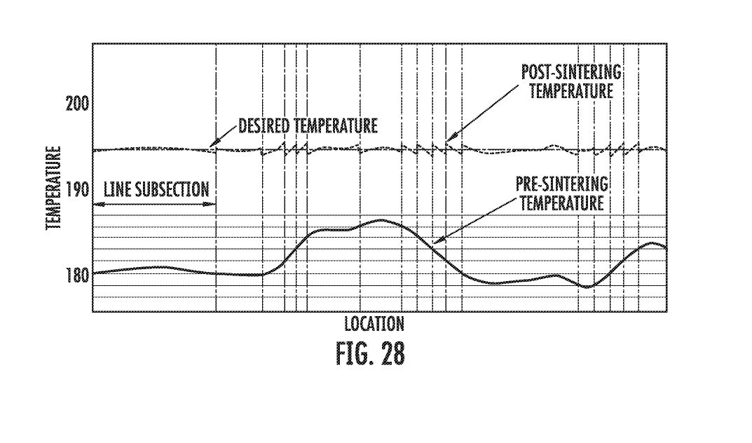

It was decided that an acceptable tradeoff between computation time and temperature control precision came from limiting the laser power percent to integer values. This creates a dynamic subsection spacing where a new subsection is created once the predicted temperature of the previous subsection reaches a certain limit. An example result of this dynamic subsection method is seen in FIG. 28. This method produces a relatively small error between the desired post-sintering temperature and the theoretically obtainable post-sintering temperature, while not adding significant time to the build.

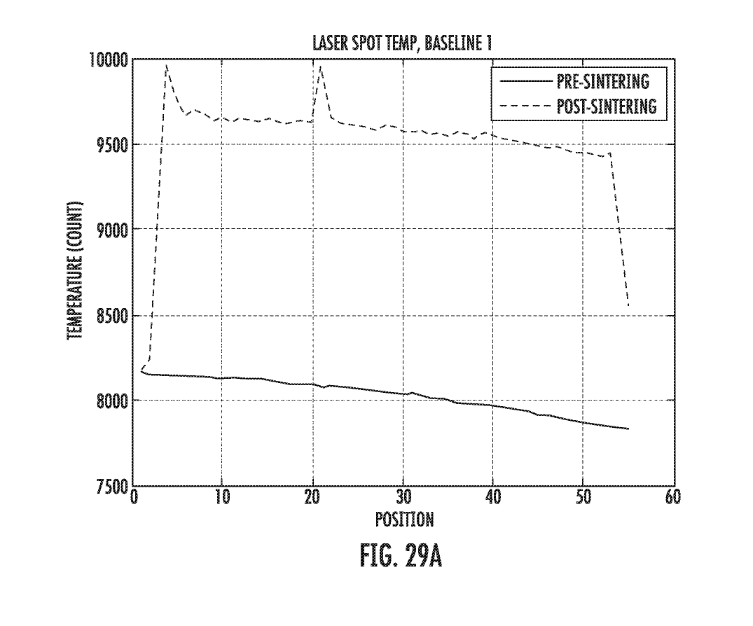

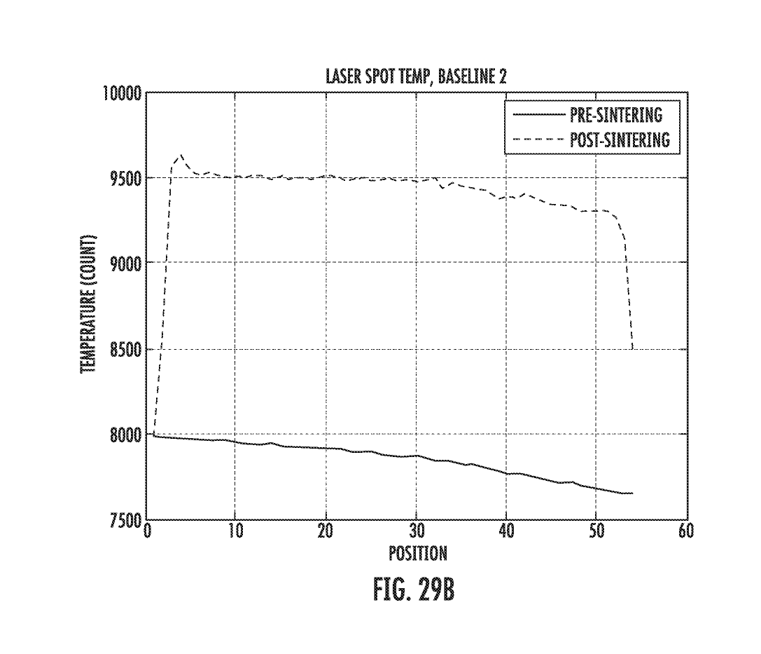

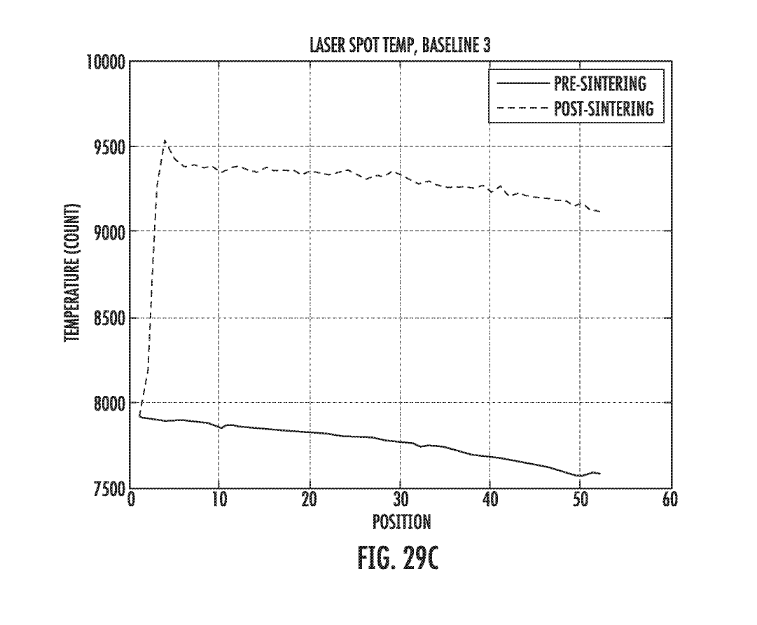

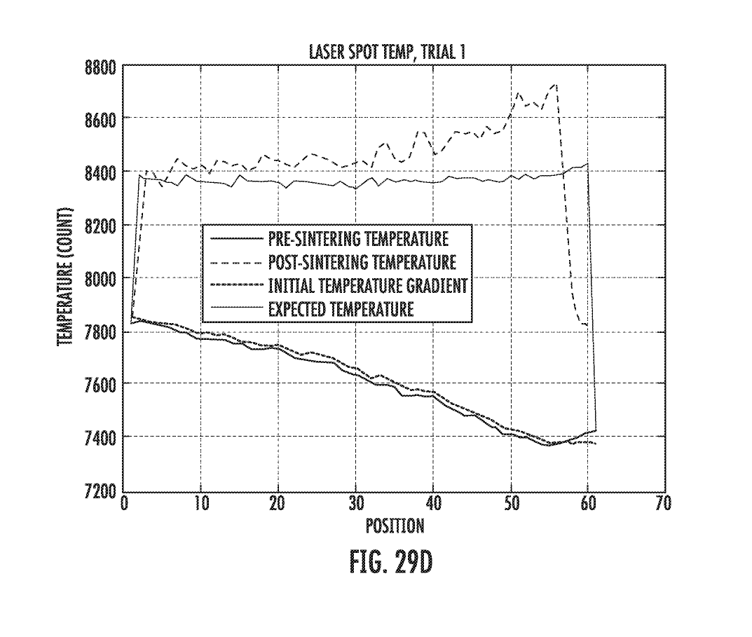

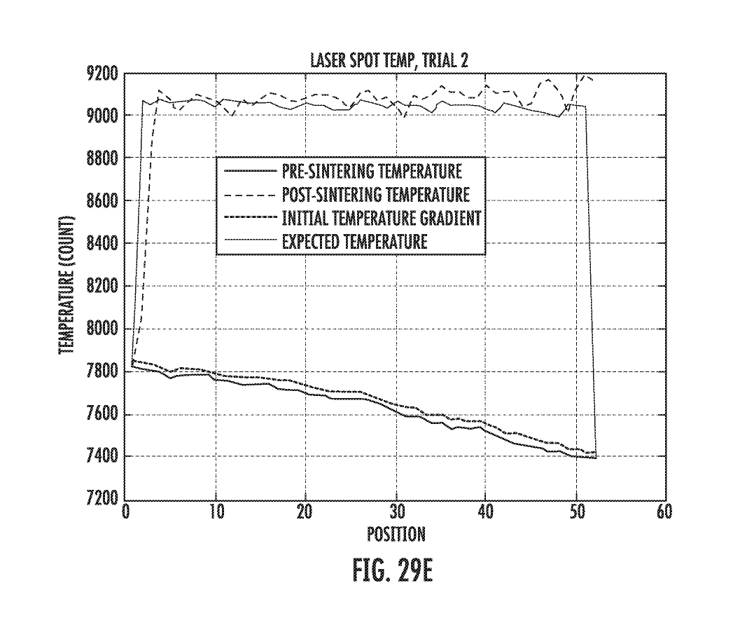

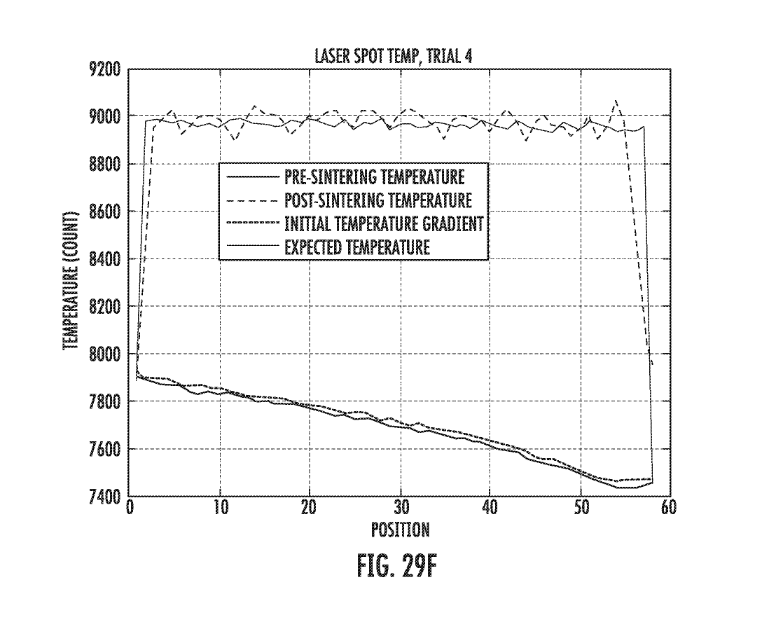

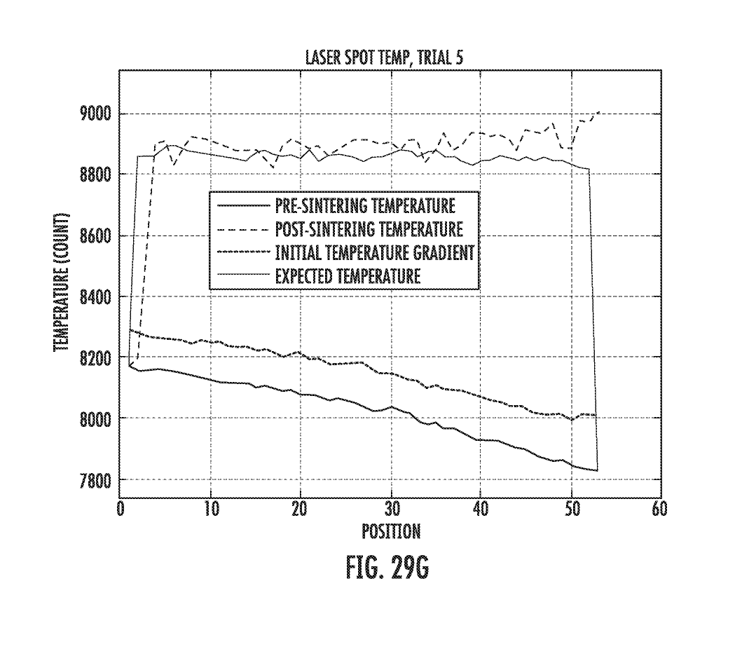

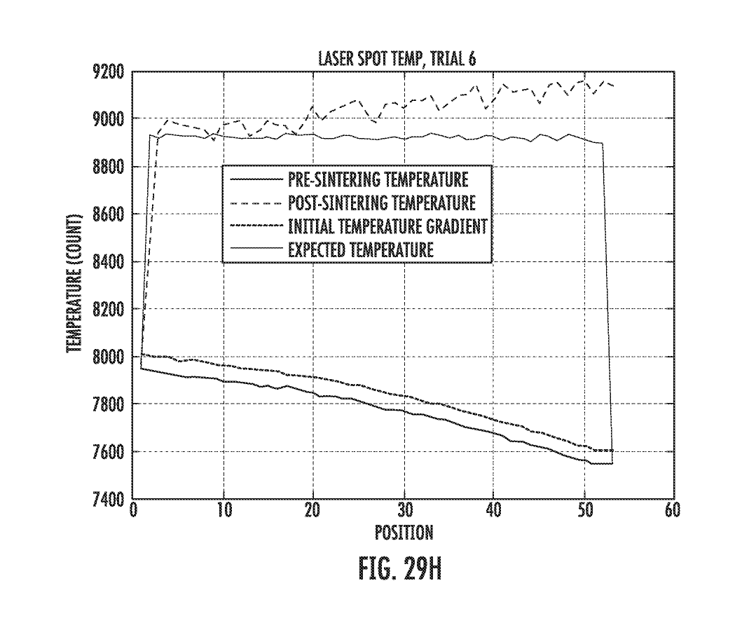

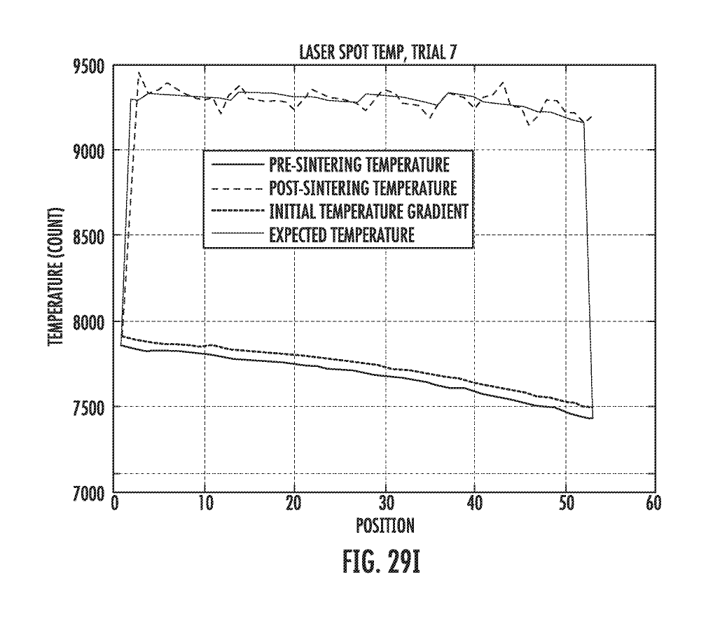

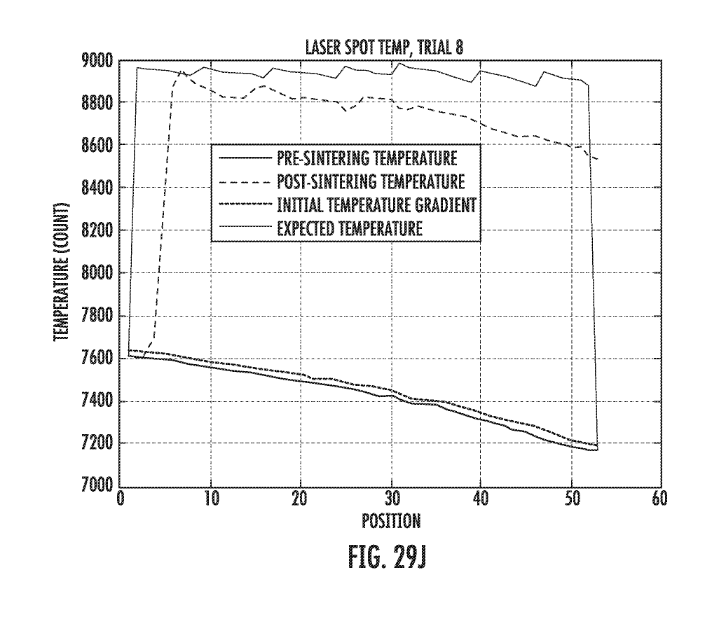

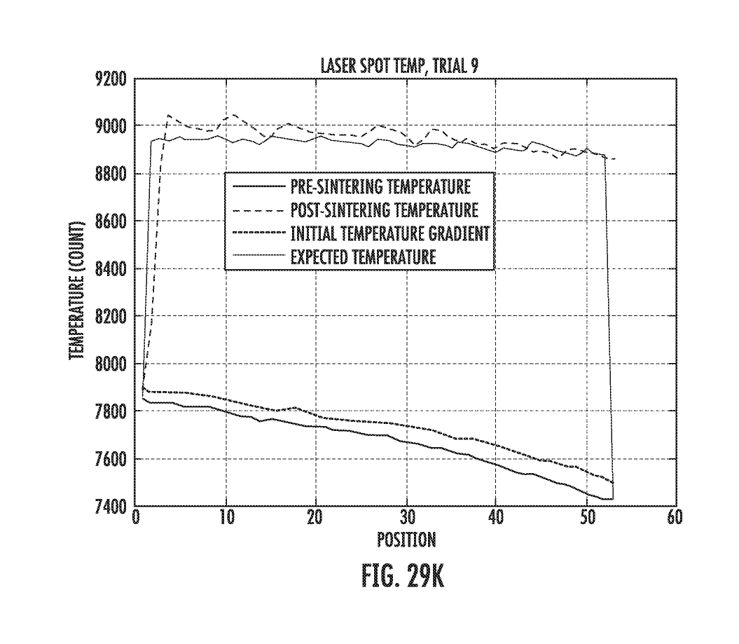

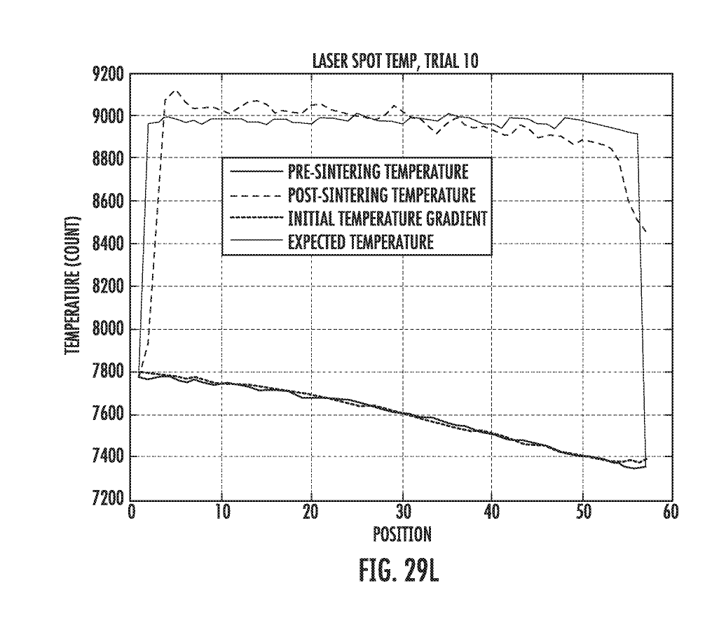

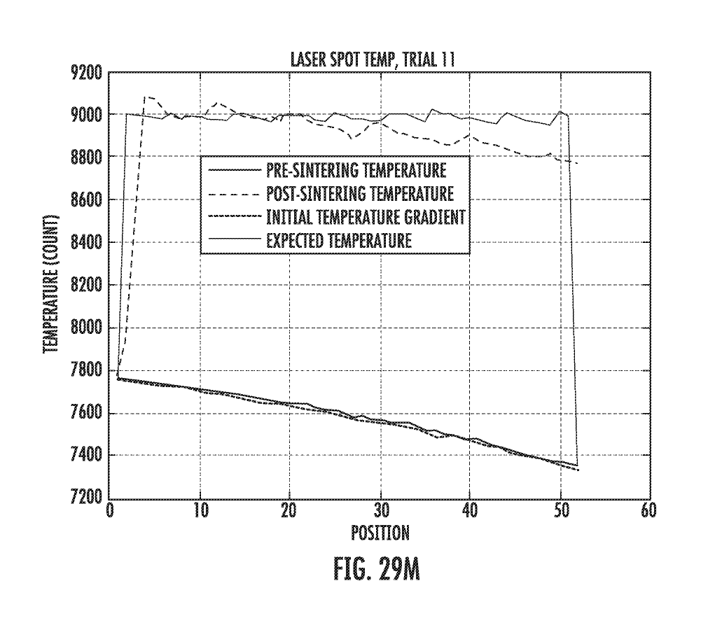

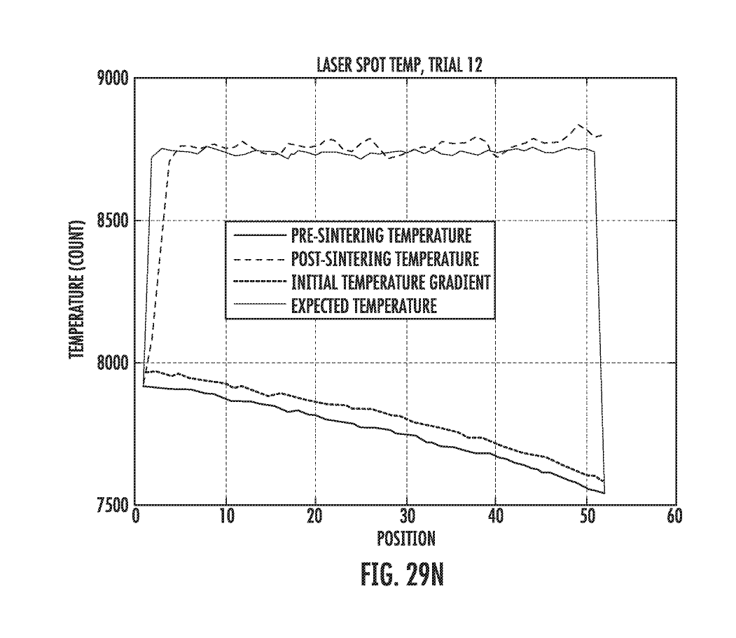

A total of 13 in-situ laser control trials were run, the majority of which showed vast improvements over the baseline, constant power trials. The number of trials is admittedly on the low side, but the results are encouraging. This section will highlight some characteristic results. Result plots for all completed trials are shown in FIGS. 29A-29N.

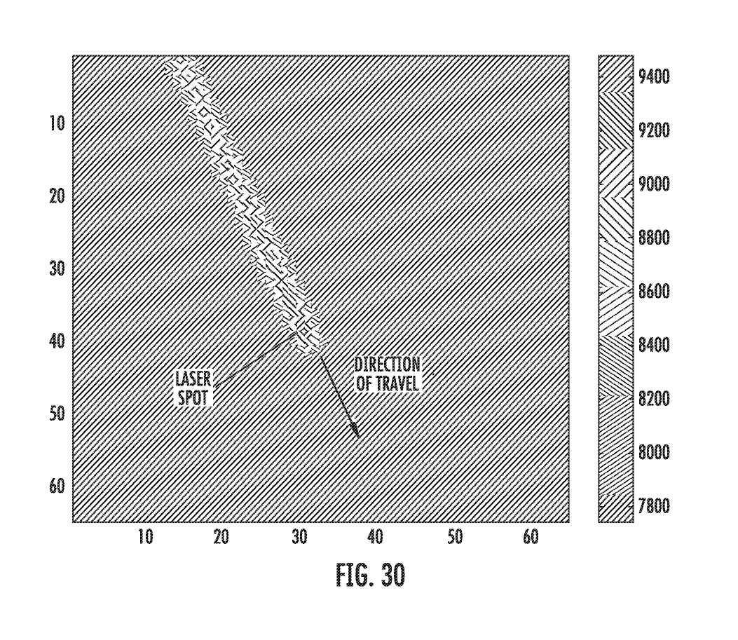

In order to understand the results from the in-situ control, the baseline results must first be analyzed. The following results are from a test run using the same procedure as the in-situ control tests except a fixed laser power was used for the entirety of the scan line. An IR image taken with the boresight MWIR camera is shown in FIG. 30. The figure identifies the pixel on the IR camera that the laser is currently firing at (the hottest pixel in view). Despite the galvanometers moving the laser, the laser spot will remain on the same pixel of the IR camera throughout the build due to the laser and MWIR camera co-alignment. The temperature of the pixel corresponding to the laser spot will be used to identify the pre-sintering and post-sintering temperatures for all trials.

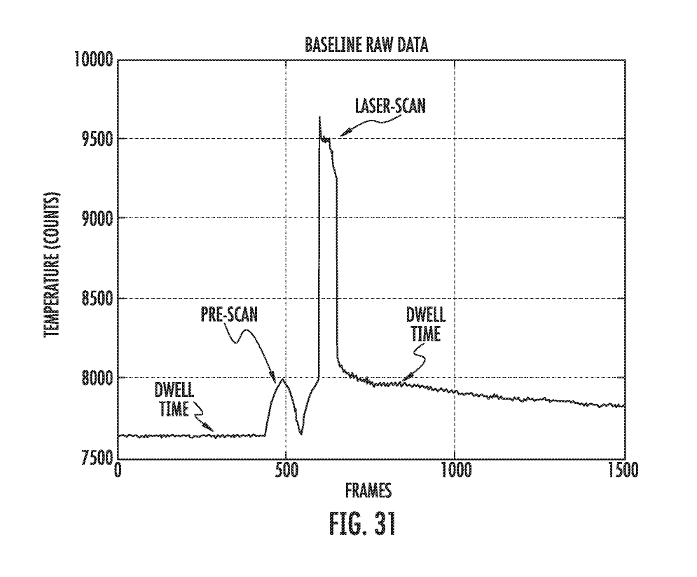

The temperature of the laser spot pixel for all 1500 frames during one of the baseline trials is shown in FIG. 31. For the first 430 frames the temperature is constant, except for some noise. This is due to the time delay between when the MWIR camera begins recording and the galvanometer begins moving. This time delay will vary from trial to trial. From frames 430 to 490 the galvanometer is moving to the beginning of the scan line. As can be seen, the temperature rises during this period due to the temperature gradient in the powder. From frames 490 to 540 the galvanometer is running the laser over the scan line with zero laser power. This step provides data on the initial temperature profile of the scan line. From frames 540 to 600 the galvanometer is returning to the beginning of the scan line. From frames 600 to 650 the galvanometer is scanning the laser line, now with a fixed, non-zero laser power. A small spike at the beginning of this region is observed due to suboptimal tuning of the velocity compensation. It is observed that the temperature profile during the lasing mimics that of the pre-scan, just at a higher temperature. From frames 650 to the end of the trial, the laser is off and the galvanometers are not moving. The temperature change observed in this region is due to heat radiating and convecting away from the newly sintered region.

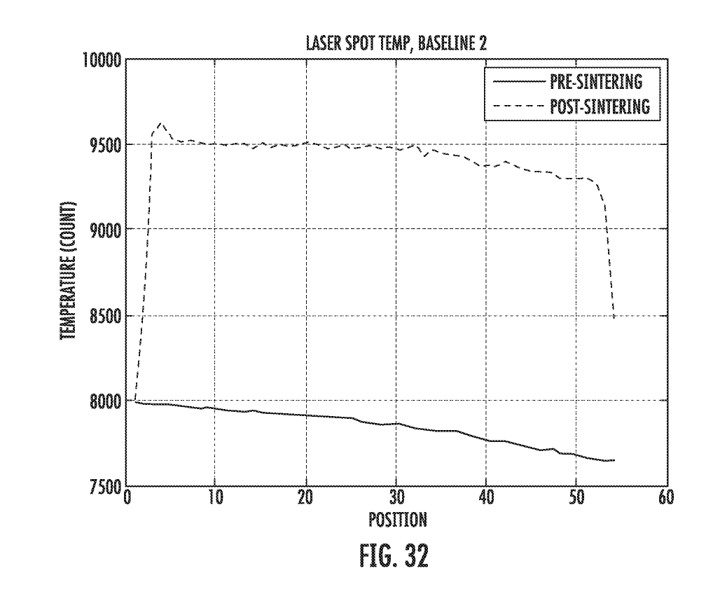

Once these regions are identified, the data can be displayed in a more useful manner. FIG. 32 shows the same data with the pre-scan and laser scan coinciding. It is much clearer from this image how the post-sintering temperature tracks that of the pre-sintering temperature. This can also be seen in Table 1, below, which displays the average temperature, the maximum difference of the temperatures and the standard deviations of the temperatures for the pre-sintering and post-sintering temperature on all three baseline trials. The table also shows the change in maximum temperature difference and standard deviation from the pre-sintering to post-sintering temperature data. All baseline trials, which can be seen in FIGS. 29A-29N, exhibit a post-sintering temperature profile that is heavily influenced by the pre-sintering profile. This effect can also be clearly seen in FIG. 23.

TABLE 1
Baseline Temperature Measurements

| | | Max Pre- | Pre- | Avg. | Max Post- | Post- | | |
|---|---|---|---|---|---|---|---|---|
| | Avg. Pre- | Sintering | Sintering | Post- | Sintering | Sintering | Temp | Temp |
| | Sintering | Temp | Temp | Sintering | Temp | Temp | Diff | STD |
| Trial | Temp. | Difference | STD | Temp | Difference | STD | Change | Change |
| 1 | 8022.6 | 291 | 88.6 | 9584.1 | 522 | 89.5 | −79.38% | −1.02% |
| 2 | 7843.7 | 314 | 93.2 | 9442.4 | 256 | 73.2 | 18.47% | 21.46% |
| 3 | 7751.7 | 316 | 97.8 | 9292.1 | 414 | 75.8 | −31.01% | 22.49% |

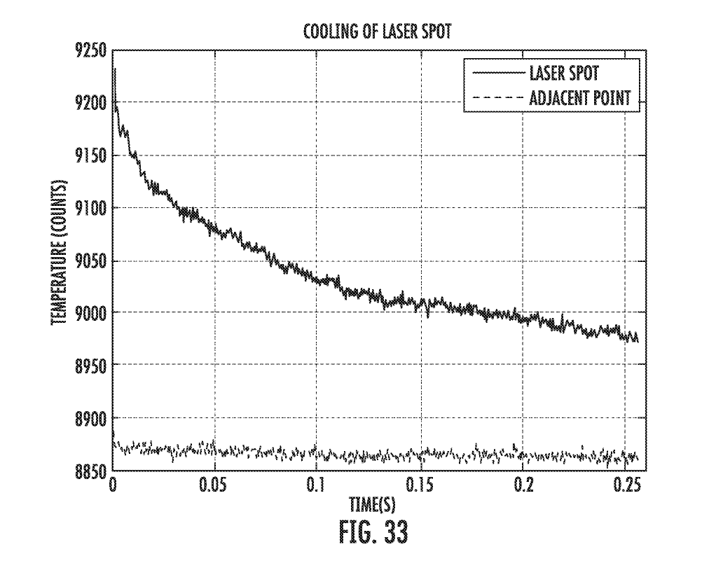

Laser control requires highly specialized sensors that collect data with resolutions not typically available. This allows for examination of complex powder phenomenon, such as determining the extent of heat conduction throughout the top layer of powder. As a product of recording large amounts of thermal data during the scan lines, data was recorded immediately following the scan line where the galvanometer is stationary. This allows for probing the temperature values for sections of the build surface as the powder cools with high resolution. The cooling temperatures can be seen in FIG. 33. The data in this figure was taken immediately following the laser turning off when the galvanometer is stationary. The blue line is the temperature recorded at the pixel corresponding to the center of the laser spot and the green line is the nearest pixel that was outside the laser spot, a mere three pixels (approximately 2.5 mm) away from the center of the laser. As can be seen, over the 0.25 seconds recorded, the laser spot pixel cooled rapidly while the adjacent point's temperature was unchanged. This supports the view that the nylon material is highly insulating and shows that radiation and convection to the build chamber are the primary modes of heat transfer on the surface of the powder and they drastically outweigh the effect of conduction.

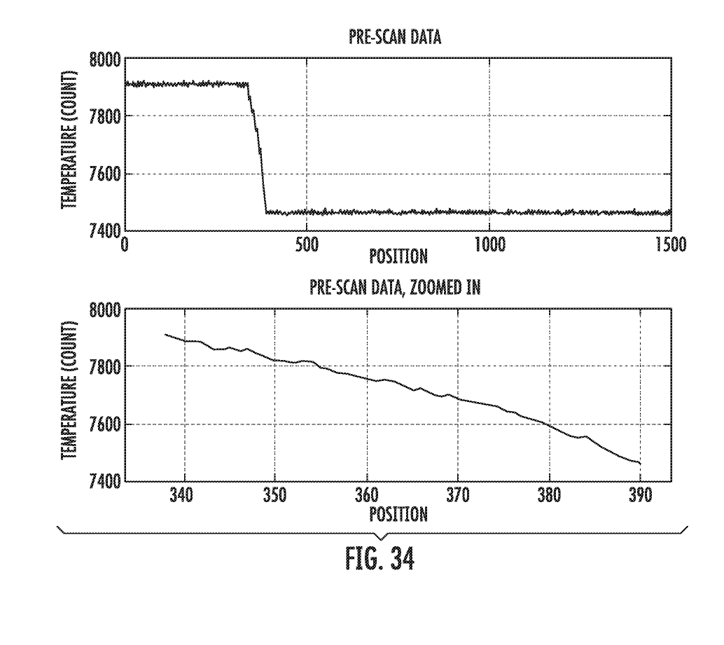

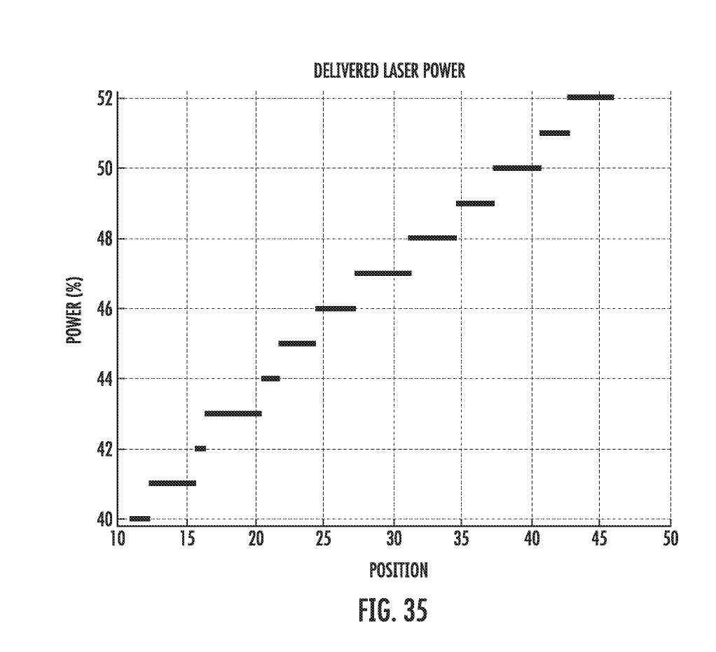

In-situ control of the laser power was performed as specified above. The pre-sintering temperature profile for one of the trials is seen in FIG. 34. The first subplot shows the raw temperature data from the pre-scan with the first 340 and the last 1100 frames being dwell time for the galvanometer. The second subplot shows a close-up of the non-dwell time region which is the temperature profile of the scan line. This temperature is fed through the laser power to temperature increase transfer function with a desired post-sintering temperature of 9000 Counts. The resulting laser power profile is seen in FIG. 35. The galvanometer coordinates for the scan line are 11-46. As can be seen, the scan line was split into 13 subsections, each with its own length and laser power percentage based on the pre-sintering temperature profile.

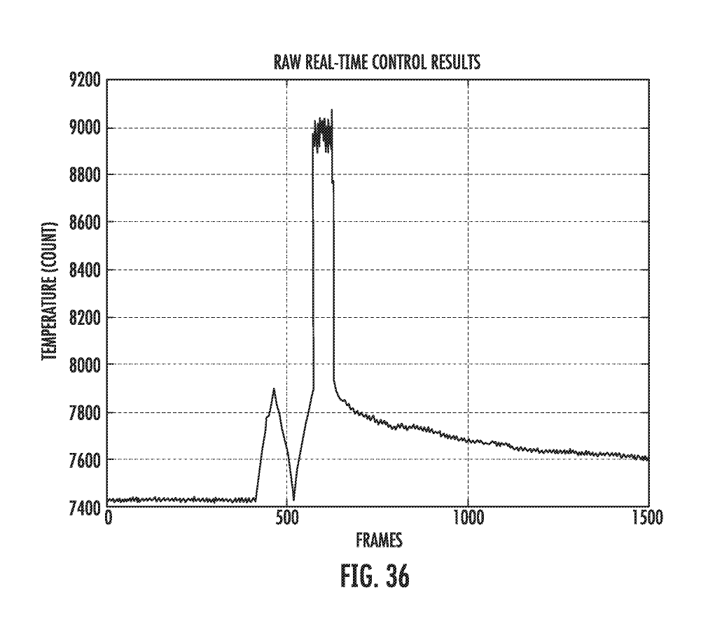

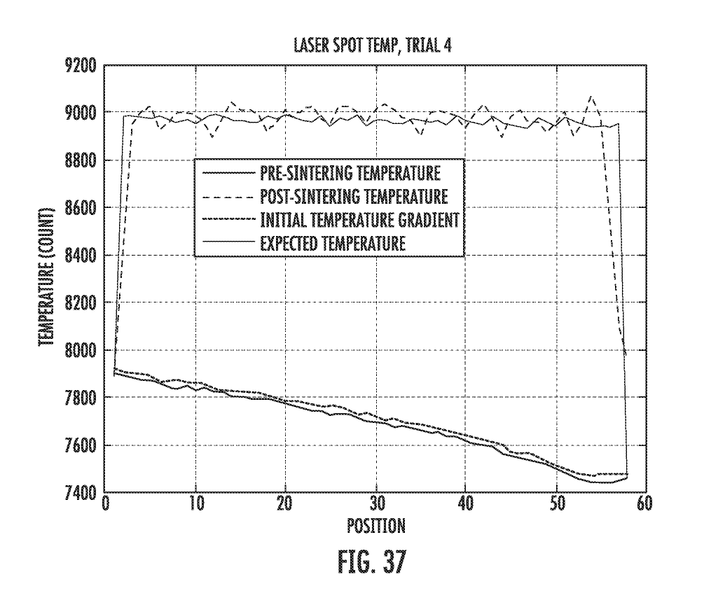

The raw result of this in-situ laser control trial is shown in FIG. 36. This data is read the same way as the raw data for the baseline trials, where the beginning and ending of the data is galvanometer dwell time, the first hump is traversing over the scan line backwards then forwards with no laser power, and the second hump is traversing over the scan backwards then forwards with the variable laser power defined in FIG. 35. FIG. 37 displays the same data with the dwell times removed and the pre-sintering temperature and post-sintering temperature coinciding. The red line is the same as the line in FIG. 34, the pre-sintering temperature that is used to determine the subsection laser power percentages. The blue line is data from the same location as the red line, but roughly two minutes later. The process to analyze the pre-sintering temperature, create a scan file, and implement the laser control took roughly two minutes. The blue line was taken as the first step of the in-situ control scan file and is used to determine the extent to which the system has changed in the two minutes since the initial data was taken. If the blue line is significantly different than the red line, it is expected that the in-situ control will not perform as expected, as the control is based off an inaccurate representation of the system at the time it is implemented. The green line is the post-sintering temperature. It is observed that this temperature is centered on the desired temperature of 9000 Counts and is not influenced by the pre-sintering temperature gradient. The black line is the result of the delivered laser power defined in FIG. 25 fed back through the laser power to temperature increase transfer function to get an expected temperature increase. This number is added to the blue line, the actual pre-sintering temperature. If the in-situ control strategy is working correctly, this line should match closely with the green line, the actual post-sintering temperature. Note that the black line is not a straight line exactly at the desired temperature because it was fed twice through the transfer function that rounded the delivered power to integer values.

This trial performed exceptionally well and showed that a high level of laser control is possible with the method proposed. The results of all in-situ control trials are displayed in Table 2, below, as well as FIGS. 29A-29N. As can be seen from the “Temp Diff Change” and the “Temp STD Change” columns of Table 2, all of the trials exhibited a post-sintering temperature profile that was superior to the pre-sintering temperature in terms of uniformity. This cannot be said of the baseline trials, whose post-sintering temperature profile mimicked the pre-sintering profile. This result indicates that the in-situ control experiments were successful and the proposed control method is valid.

It should be noted that the data is missing for trials 3, 8, and 13. This is due to errors in the implementation of control for those trials, not from flaws in the control method. On trial 3, the scan file was corrupt and caused the laser to double scan a subsection of the line, resulting in a large temperature spike. This occurred because of a bug in the MATLAB file used for creating the scan files. During trial 8, the bore-sighted MWIR camera was shifted slightly prior to the initial pre-sintering temperature profile being recorded. This caused the pixel corresponding to the laser spot to shift and the power percentages being calculated off the incorrect spots on the powder surface. The result was a line whose power was not determined by its own initial thermal profile, but from an adjacent line. Trial 13 is believed to have been successful, but the data was not recorded successfully by the MWIR camera. The recording of the MWIR camera is triggered off the initialization command from the EC1000 at the start of sintering. The MWIR camera software reliable responds quickly to this trigger and begins recording immediately, but the EC1000 and galvanometer have a time delay. During this trial, the delay exceeded the time it took for the camera to record the predetermined 1500 frames (approximately 670 milliseconds) and, thus, the post-sintering temperature was not recorded. The data in Table 2 shows that all in-situ control trials outperformed the baseline temperature gradient, yet to a varying extent

TABLE 2
In-Situ Control Temperature Measurements

| | | Max Pre- | Pre- | Avg. | Max Post- | Post- | | |
|---|---|---|---|---|---|---|---|---|
| | Avg. Pre- | Sintering | Sintering | Post- | Sintering | Sintering | Temp | Temp |
| | Sintering | Temp | Temp | Sintering | Temp | Temp | Diff | STD |
| Trial | Temp. | Difference | STD | Temp | Difference | STD | Change | Change |
| 1 | 762 | 457 | 142.2 | 8482.8 | 389 | 89.28 | 14.88% | 37.22% |
| 2 | 762.2 | 402 | 126 | 9083.6 | 210 | 41.91 | 47.76% | 66.74% |
| 3 | — | — | — | — | — | — | — | — |
| 4 | 7682.4 | 439 | 124.5 | 8978.1 | 183 | 40.8 | 58.31% | 67.23% |
| 5 | 8018.4 | 326 | 96.6 | 8901.6 | 149 | 31.5802 | 54.29% | 67.31% |
| 6 | 7768.9 | 377 | 114.6 | 9042.1 | 245 | 68.4 | 35.01% | 40.31% |
| 7 | 7677.3 | 374 | 110.2 | 9292.4 | 250 | 52.9 | 33.16% | 52.00% |
| 8 | — | — | — | — | — | — | — | — |
| 9 | 7663.7 | 396 | 112.2 | 8953.3 | 191 | 45.3 | 51.77% | 59.63% |
| 10 | 7610.4 | 385 | 114.8 | 8988.2 | 258 | 60.9 | 32.99% | 46.95% |
| 11 | 7575.1 | 391 | 116.4 | 8931.2 | 303 | 79.8 | 22.51% | 31.44% |
| 12 | 7745 | 355 | 103 | 8761 | 124 | 24.2 | 65.07% | 76.50% |
| 13 | — | — | — | — | — | — | — | — |

Described herein is an example of a method of in-situ laser control for SLS and details the results of testing the control method. The hypothesis that the traditional, fixed laser power method of sintering would uniformly increase the temperature of the powder and preserve its initial temperature gradient was confirmed. This revealed the need for an improved control method where the initial powder bed temperature profile could be diminished. The method proposed is to measure the powder surface with a sensor such as a MWIR sensor, determine the difference between the current temperature and the desired temperature, then regulate the laser energy deposition in order to counteract the thermal profile and achieve a uniform post-sintering temperature.

The results of testing are overwhelmingly positive, with each test outperforming the baseline control method. Temperature variations throughout a scan line were shown to greatly diminish using the in-situ control method employed. The effect of the pre-sintering thermal profile on the post-sintering temperature was reduced up to 65%. While not every trial performed exceptionally well, all showed improvement over the baseline. This increased control over laser energy deposition and the corresponding decrease in post-sintering temperature gradients is advantageous for creating high-quality components via Selective Laser Sintering. By decreasing the thermal gradient in the post-sintering part, the mechanical and dimensional properties of the part can be improved.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

Throughout this application, various publications may be referenced. The disclosures of these publications in their entireties are hereby incorporated by reference into this application in order to more fully describe the state of the art to which the methods and systems pertain.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

1. A method of real-time laser control for powder bed fusion comprising:
obtaining a pre-sintering temperature of at least one or more points of a scan line of a powder to be sintered;
determining a difference between the pre-sintered temperature of at least one of the one or more points on the scan line of the powder to be sintered and a desired temperature; and
adjusting a power setting of a laser such that when the laser is applied to the at least one of the one or more points a temperature at that point is approximately the desired temperature.

2. The method of claim 1, wherein obtaining the pre-sintering temperature of at least one or more points of the scan line of a powder to be sintered comprises obtaining a pre-sintering temperature distribution of at least a portion of the scan line of a powder to be sintered.

3. The method of claim 2, wherein the pre-sintering temperature distribution is determined for the scan line before sintering along the scan line begins.

4. The method of claim 1, wherein obtaining the pre-sintering temperature of at least one or more points of the scan line of a powder to be sintered comprises obtaining the pre-sintering temperature of the at least one or more points of the scan line of a powder to be sintered using one or more sensors.

5. The method of claim 4, wherein the one or more sensors comprise infrared sensors.

6. The method of claim 5, wherein the infrared sensors comprise at least one mid-wavelength infrared camera.

7. A method of selective laser sintering (“SLS”) comprising:
measuring a temperature of a powder surface;
determine a difference between the measured temperature and a desired temperature of the powder surface; and
regulating energy deposition of a laser in order to achieve a substantially uniform post-sintering temperature.

8. The method of claim 7, wherein measuring the temperature of the powder surface comprises measuring the temperature of the powder surface along a scan line for sintering.

9. The method of claim 7, wherein the temperature of the powder surface is measured using an infrared sensor.

10. The method of claim 9, wherein the infrared sensor comprises a mid-wavelength infrared camera.

11. The method of claim 8, wherein the difference between the measured temperature and the desired temperature of the powder surface is determined along the scan line.

12. The method of claim 11, wherein the determined difference between the measured temperature and the desired temperature of the powder surface along the scan line is used to create a thermal profile along the scan line.

13. The method of claim 12, wherein the thermal profile for the scan line is created before sintering along the scan line begins.

14. The method of claim 12, wherein the thermal profile is used to dynamically regulate energy deposition of the laser on the powder as the laser moves along the scan line to achieve the substantially uniform post-sintering temperature.

15. The method of claim 1, wherein the powder comprises Nylon 12 (ALM PA 650) powder.

16. An apparatus for producing a part from a powder using a powder sintering process, comprising:
a build chamber including one or more walls, wherein the build chamber encloses a build cylinder and a build surface;
a build piston configured to support the powder and the part, wherein the build piston is arranged at least partially within the build cylinder;
an energy source configured to produce and direct an energy beam to the build surface;
one or more temperature measurement devices; and
a controller, wherein the controller executes computer-readable instructions that cause the controller to obtain a temperature of the powder surface, determine a difference between the measured temperature and a desired temperature of the powder surface; and
regulate energy deposition of the energy source in order to achieve a substantially uniform post-sintering temperature.

17. The apparatus of claim 16, wherein the apparatus further comprises a plurality of heat sources distributed in at least one of the walls of the build chamber, the build cylinder and the build piston, wherein the controller further executes computer-readable instructions to control the heat sources.

18. The apparatus of claim 16, wherein the energy source is arranged outside of the build chamber.

19. The apparatus of claim 16, wherein the controller controls the heat sources to maintain an approximately uniform temperature distribution within the build chamber during the powder sintering process.

20. The apparatus of claim 16, wherein the one or more temperature measurement devices comprise at least one multi-spectral imaging device that acquires images of measuring the temperature of the powder surface along a scan line for sintering.

21. The apparatus of claim 20, wherein the multi-spectral imaging device is an infrared imaging device.

22. The apparatus of claim 21, wherein the infrared sensor comprises a mid-wavelength infrared camera.

23. The apparatus of claim 16, wherein the controller executes computer-readable instructions that cause the controller to determine the difference between the measured temperature and the desired temperature of the powder surface along the scan line.

24. The apparatus of claim 23, wherein the controller executes computer-readable instructions that cause the controller to use the determined difference between the measured temperature and the desired temperature of the powder surface along the scan line to create a thermal profile along the scan line.

25. The apparatus of claim 24, wherein the thermal profile for the scan line is created before sintering along the scan line begins.

26. The apparatus of claim 24, wherein the controller executes computer-readable instructions that cause the controller to use the thermal profile to dynamically regulate energy deposition of the laser on the powder as the laser moves along the scan line to achieve the substantially uniform post-sintering temperature.

27. The apparatus of claim 20, wherein the at least one multi-spectral imaging device comprise a bore-sighted multi-spectral imaging device.

28. The apparatus of claim 16, further comprising an energy beam power meter configured to measure a power of the energy beam, wherein the energy beam power meter is arranged near the build surface within the build chamber, and wherein the controller executes computer-readable instructions that cause the controller to regulate energy deposition of the energy source in order to achieve a substantially uniform post-sintering temperature by receiving the power of the energy beam; and control the energy source based on the power of the energy beam measured within the build chamber.
